(19) United States
(12) Patent Application Publication
(10) Pub. No.: US 2016/0226865 A1
(43) Pub. Date: Aug. 4, 2016

(54) MOTION BASED AUTHENTICATION SYSTEMS AND METHODS

(71) Applicant: AirSig Technology Co. Ltd., Taipei (TW)

(72) Inventors: PO-KAI CHEN, Taoyuan (TW); YU-JIE CHEN, Taichung (TW); YU-CHENG HO, Yunlin (TW); MENG-HSI CHUANG, Taipei (TW)

(73) Assignee: AirSig Technology Co. Ltd., Taipei (TW)

(21) Appl. No.: 15/007,268

(22) Filed: Jan. 27, 2016

Related U.S. Application Data
(60) Provisional application No. 62/109,118, filed on Jan. 29, 2015.

(51) Int. Cl. H04L 29/06; G06Q 20/40; H04W 12/06

(52) U.S. Cl. CPC H04L 63/0853; H04W 12/06; G06Q 20/40; G06Q 2220/00

(57) ABSTRACT

A motion-based authentication method of authenticating a user with a mobile device is provided. A pre-training routine is conducted to detect an orientation characteristic and a duration characteristic associated with a user input. A training routine is conducted to capture a set of base signatures and to compute the consistency level associated with the signatures. A verification routine is conducted to compare the target signature with the set of base signatures. Authorization is granted if the target signature has reached the similarity threshold with respect to the base signatures.

### CROSS REFERENCE TO RELATED APPLICATIONS

This non-provisional application claims priority to a U.S. Provisional Patent Application Ser. No. 62/109,118, filed on Jan. 29, 2015. The entire contents of which are hereby incorporated by reference.

### BACKGROUND OF THE INVENTION

1. Field of Invention

The present invention relates generally to a motion-based authentication system, and more particularly to motion-based authentication systems and methods to authenticate and allow a user of a mobile device to access an access-restricted resource.

2. Related Art

A mobile device may be any computing device. This may include mobile computers, mobile phones, mobile web, mobile internet devices, smartphones, feature phones, tablet computers, wearable computers, watches, calculator watches, smart watches, head-mounted displays, personal or enterprise digital assistants, calculators, scientific calculators, game consoles, portable media players, ultra-mobile pcs, digital still cameras, digital video cameras, digital camcorders, pagers, navigation devices, robots, smart button, or smart cards.

A computing device has an operating system (OS) and can run various application software on its OS. Most computing devices can also make connections to the Internet or to another device through Wi-Fi, Bluetooth, NFC and GPS. Connections to another device may be a computing device, or a non-computing device, such as a microphone headset. Other features that a computing device may have include a camera, media player or sensors, such as accelerometers, magnetometers, or gyroscopes, allowing the detection of orientation and motion.

Mobile devices have increasingly become an essential tool in everyday life, and since mobile devices are portable and may store personal information, it may become a target for theft, or risk being lost. In order to prevent any unauthorized use of the device once it has been stolen or lost, many portable devices nowadays utilize an electronic authentication system to protect sensitive information stored in the device. This may include a personal identification number, username, password. It can also include inputting a sequence of touch press by using a keyboard or touch screen.

Another existing electronic authentication technology is biometric inputs, such as voice recognition, face recognition, fingerprint identification and retina scanner. These biometric technologies may be impractical in certain instances. For example, voice recognition authentication may not be functional when the user's voice becomes compromised from an illness. In addition, biometric authentication methods are usually more expensive to implement, raise more concerns for the invasion of user privacy, and the biometric password can't usually be changed.

Consequently, the existing electronic authentication technologies have certain limitations that require further breakthrough, and an easier method for authentication is desired.

### SUMMARY OF THE INVENTION

The present invention provides a fast, secure, and low-cost method of authentication. In some embodiments of the present invention, a motion-based authentication method of authenticating a user with a mobile device is provided. In some embodiments, the motion-based authentication method can take less than 0.1 second to recognize air signature pattern with over 99% accuracy rate. In some embodiments, the motion-based authentication method can be applied to login authentication, payment authorization, digital signing or approval, and internet of things. The motion-based method may include a pre-training routine to detect an orientation characteristic and a duration characteristic associated with a user's input. In addition, the motion-based method may include a training routine to capture a set of base signatures, and to compute the consistency level associated with the base signatures.

In some embodiments of the present invention, a verification routine is conducted to compare the target signature with the set of base signatures. Authorization is granted if the target signature has reached the similarity threshold with respect to the base signatures.

In some embodiments of the present invention, an adaptive learning routine is conducted to incorporate the qualified target signature into the base signature set.

### BRIEF DESCRIPTION OF THE DRAWINGS

The objects and features of the invention can be better understood with reference to the drawings described below and the claims. The drawings are not necessarily to scale. Emphasis is present for illustrating the general principles of the present invention.

FIG. 1 illustrates an embodiment of the mobile device in accordance with the present invention.

FIG. 2 shows a motion-based authentication method in accordance with the principles of the present invention.

FIG. 3 shows the pre-training module of a motion-based authentication method in accordance with the principles of the present invention.

FIG. 4 shows the training module of a motion-based authentication method in accordance with the principles of the present invention.

FIG. 5 shows the verification module of a motion-based authentication method in accordance with the principles of the present invention.

FIG. 6 shows an architecture diagram in accordance with the principles of combining with user behavior and implied automatic user authentication.

FIG. 7 shows a flowchart of an air signature operation method in accordance with combining with user behavior and implied automatic user authentication.

FIG. 8 shows an architecture diagram in accordance with the principles of combining with holding/picking-up behavior and implied automatic user authentication.

FIG. 9 shows a flowchart of an air signature operation method in accordance with combining with holding/picking-up behavior and implied automatic user authentication.

FIG. 10 shows an architecture diagram in accordance with the principles of combining with selection behavior and implied automatic user authentication.

FIG. 11 shows a flowchart of an air signature operation method in accordance with combining with selection behavior and implied automatic user authentication.

### DETAILED DESCRIPTION OF THE INVENTION

The present invention will be apparent from the following detailed description, which proceeds with reference to the accompanying drawings, wherein the same references relate to the same elements.

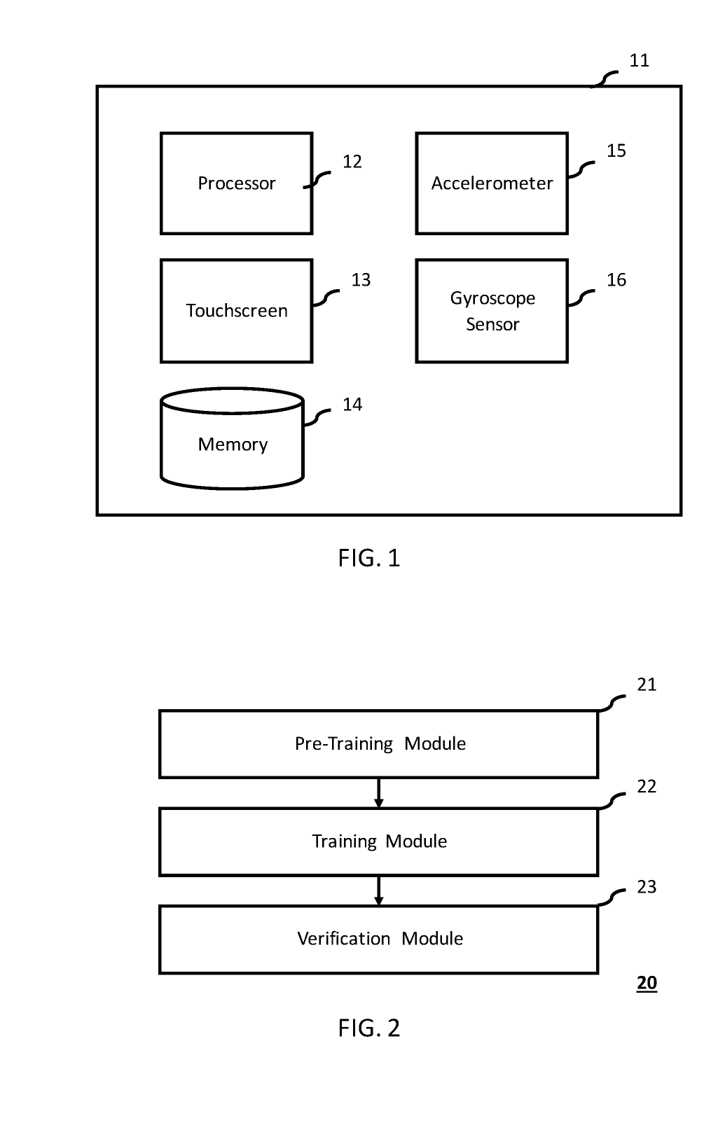

FIG. 1 illustrates an embodiment of the mobile device in accordance with the present invention. The mobile device 11 may be a device that is capable of being moved by hand to provide a motion-based air signature. In a preferred embodiment, the mobile device may be a smartphone. As illustrated, the mobile device 11 may include a processor 12 that may be used to conduct the instructions of a computer program by performing the basic arithmetic, logical, control and input/output operations specified by the instructions. The mobile device 11 may also include a touch screen 13 as a display and input device for the mobile device. The touch screen 13 may enable a user to interact directly with what is displayed. Additionally, the mobile device 11 may include a memory 14, which may function as a computer hardware device used to store information for use by the mobile device 11.

In accordance with some embodiments of the present invention, the mobile device 11 also includes an accelerometer 15. The accelerometer 15 is a device that measures linear acceleration. The accelerometer 15 may be a single-axis or multi-axis models of an accelerometer. In a preferred embodiment, the accelerometer 15 can provide an immediate, three-dimensional acceleration data. The motion-based authentication system may receive the accelerometer data by registering an application object. This will allow the system to receive acceleration readings along the three axes of the device. In some embodiments, the mobile device 11 provides the accelerometer reading values in units of the g-force.

In addition, the mobile device 11 may use the accelerometer reading to measure the acceleration effect of Earth's gravity on the mobile device 11. When the mobile device 11 is held up at a substantially steady state, the source of gravity acceleration is due to the gravity pull from the Earth. Therefore, with the accelerometer reading along the X, Y and Z axes, the mobile device 11 can calculate the tilt of the device relative to the direction of Earth gravity.

Additionally, the mobile device 11 may include a gyroscope sensor 16, which measures the rate at which a mobile device 11 rotates around each of the three spatial axes.

FIG. 2 shows a motion-based authentication system 20 in accordance with some embodiments of the present invention. In some embodiments, the authentication system 20 may be used to set an authentication policy requirement associated with an access-restricted resource. The authentication system 20 may grant access to the access-restricted resource when the authentication policy requirement has been properly fulfilled.

To set the authentication policy requirement, the authentication system 20 may first assist the user to select the access-restricted resource that the user would like to access. It can then assist the user to set and confirm the access requirement for granting access to such resource. For example, an access-restricted resource may be any digital resource, such as home screen, account profile, payment authorization, customized page, printing privilege or direct access to another application. The access requirement for the resource may be an air signature, which is a three-dimensional motion that a mobile device can capture. The access requirement can be met when such air signature (target signature) matches the signatures that have been pre-stored in the authentication system 20's database (base signatures) when the user first set the authentication policy requirement in the training stage.

A person of ordinary skill in the art would recognize that there can be more than one way to access an access-restricted resource. For example, a user can unlock a smartphone lock screen by entering a password or by using fingerprint access. Hence, an “access-restricted resource”, as used herein, includes generally a resource that can be accessed through the authentication system 20. Specifically, it may include a native application installed and executed on either the mobile device or an external device. It can also include a web application running on a web server, as well as a user-agent-based application in which the client code is downloaded from a remote server and executes within a local user-agent like a web browser. It can also include any module or programming routine within these applications.

In some embodiments, the access-restricted resource may be a specific action associated with the application. For example, in a gesture recognition game, the mobile device may be used as the input device for the gesture recognition system, wherein a particular signing pattern may be associated with an attach motion and another signing pattern may be associated with a defense motion. In addition, the accuracy of the signatures may be associated with the strength of these actions, wherein the more accurate signature will provide a stronger attack or defense action.

In some embodiments, the motion-based authentication method may be used with another authentication method. For example, it may be used in sequence with a password, fingerprint, voice authentication, or other biometric or non-biometric authentication system, wherein the user may first be asked to pass the access-restricted authentication method before being asked to pass the another authentication method, or vice versa. In other embodiments, the motion-based authentication method may be used concurrently with another authentication method. For example, the user may perform the voice recognition or fingerprint recognition while performing the air signature.

In some embodiments, the motion-based authentication method may be used to establish the initial authentication state. Once established, a continuous authentication system may be used to prolong the authentication state. The continuous authentication system may include a walking pattern recognizer, a cardiac-rhythm recognizer, facial pattern recognizer, keyboard typing pattern recognizer, or touchscreen pattern touching recognizer. For example, in a smart watch with a motion sensor and a heart rate sensor, a user may first use an air signature to authenticate himself. Once authenticated, the smart watch will continue to monitor the user's heart rate to determine whether the same user is still wearing the smart watch. If he is, then the authentication status is prolonged.

In some embodiments, the motion-based authentication method can be applicable to a smart watch or smart ring that can detect the connecting status of the terminal parts of the band. For example, when the user first wears a smart watch, the user will first connect the terminal parts of the band. Once connected, the user may perform the air signature to obtain the initial authentication status. Once authenticated, the authentication status will be prolonged until the terminal parts of the band are decoupled.

Although one of the intended use of the present invention is for air signature authentication, the scope of the present invention is not so limited. The authentication technique can be applicable to other biometric and non-biometric authentication, including walking pattern recognition, cardiac-rhythm recognition, facial recognition, keyboard typing pattern recognition, and touchscreen touching and swiping pattern recognition.

In some embodiments, the access-restricted resource is another application in the mobile device. In this regard, the authentication system may function as a quick launcher for a plurality of applications. For example, the authentication system may be incorporated into a locker application that also realizes short-cut activation of some applications in the mobile device. As such, a user can first configure his preferred signatures associated with the intended applications. For example, a user can sign “facebook” to be associated with the Facebook application, and “cam” to be associated with the camera application. Once these signatures have been established, when the mobile device is in a locked status, the user can sign either “facebook” or “cam” to unlock the mobile device. If the user correctly signs “facebook”, the mobile device will be unlocked to activate the Facebook application. If the user correctly signs “cam”, the mobile device will be unlocked to activate the camera application. This will allow a user to unlock a mobile device and activate the intended application in one step, as opposed to unlocking the screen, finding the application, and activating the application.

In some embodiments, the unlock-to-activation method may be performed even when the screen of the mobile device is turned off. For example, the mobile device may be equipped with the always-on context awareness sensor hub, delivered through the computation and fusion of data from numerous sensors located within the mobile device. If so, even when the mobile device is in a locked state with its screen turned off, the mobile device may still capture the motion data to allow the motion-based authentication method in accordance with the present invention. Under this architecture, the user can pick up the phone and signs the signature (e.g., “cam”) associated with the intended application (e.g., “camera application”) to activate the application, without the need to wake up the phone, or to turn on its screen beforehand.

Instead of configuring and memorizing different signatures associated with different applications, the user may want to use one signature to unlock and activate the intended application in one step. In some embodiments, the mobile device may include a touchscreen display. When the mobile device is in a locked status, the touchscreen display may display multiple graphical icons associated with the multiple applications. As such, when a user wants to unlock a mobile device to activate one of the applications, the user can touch or press on the icon associated with the intended application and begin signing his signature. If the signature is acceptable, then the mobile device will be unlocked and the application will be activated.

In some embodiments, the mobile device may be a smart button that is configured to perform a pre-defined task by signing with the smart button. For example, with the press of the button, the user may begin to perform the air signature. Once authorized, the button may automatically place an order to a remote server. Upon receiving the order, the remote server may optionally send an order confirmation to the user's phone to allow the user to cancel the order if the user has a change of mind.

In some embodiments, the motion-based authentication system may be used to select a payment method associated with a pre-configured signature. For example, when a user is using a smart credit card (e.g. all-in-one credit card) that virtually incorporates multiple plastic credit cards into one smart card, the user may need to select which credit card to associate a payment with. By combining the smart card with the motion sensors, the user may accomplish this selection by associating a unique air signature with each of the incorporated credit card. For example, when the user has a VISA credit card and a MasterCard credit card, the user may use the signature “VISA” to authorize payment through the VISA credit card, and use the signature “MASTER” to authorize payment through the MasterCard credit card.

In some embodiments, the motion-based authentication system may be used for payment authorization purposes. For example, the air signature authentication may accompany the NFC, mobile, messaging application, online shopping cart payments as an add-on security (e.g. the user will need to pass the motion-based authentication method to authorize the payment), payment method selection (e.g. the user may use air signature to select which credit card to use for the payment), or the combination of both.

In some embodiments, a user may first register his signature with the issuing bank of a credit card. Once registered, when the user wants to authorize a payment, the user will need to provide his air signature to the issuing bank. The issuing bank will then compare and authorize the transaction based on whether the provided signature is substantially similar to the signature on file. The air signature may be provided through a user's mobile device, or a customized mobile device located at the point of transaction.

In some embodiments, a mobile device that incorporates the motion-based authentication system may be used to authenticate an application device from the server device. For example, the mobile device may be a smart phone, the application device may be a personal computer and the server device may be a web server. When the personal computer is attempting to access an access-restricted resource (e.g. account information, payment history, shopping cart, etc.) from the web server, the web server may direct the user to a login module to require login information. Normally, the user will then enter his user name and password to authenticate himself. In addition, the login module may include a means for passing the login requirement from the personal computer to the smart phone. For example, the web server may display a QR code in the login module on the screen of the personal computer. The QR code can then be scanned by the smart phone to activate the motion-based authentication system, wherein the user will then provide his air signature. If the air signature provided passes the acceptance criteria, the smart phone may communicate with the web server to authenticate the personal computer. Such authentication may allow the personal computer to be redirected from the login module to a webpage displaying the access-restricted resource. Alternatively, if the connection between the smart phone and the web server is limited, the smart phone may generate on its touchscreen another QR code that indicates the passing status. This QR code may then be scanned by the camera of the personal computer to provide the authenticated status to the web server. A person of ordinary skill in the art would recognize that the QR code is only one of the means for transferring the authentication information between the mobile device and the application device. They may also include Bluetooth, Wi-Fi Direct, Wi-Fi, NFC, etc.

In some embodiments, the motion-based authentication system may be used to control a remote device or multiple remote devices. When there is only one remote device, the user can configure multiple signatures, each associated with a specific action on the remote device. After the configuration, the user can trigger the associated action by signing the associated signature. For example, the remote device may be a TV, and the user may associate the “U” signature to turn up its volume, and associate the “D” signature to turn down its volume.

In some embodiments, when there are multiple remote devices, the user may first use the mobile device to appoint via air signature which of the remote devices to give the command to. Once appointed, a user will use air signature to activate the associated action. For example, the multiple remote device may be a smart lamp and a TV. The user may associate the signatures “TV” for appointing the TV, “ON” to turn on the TV, “OFF” to turn off the TV, “U” to turn up the TV's volume, “D” to turn down the TV's volume, “LAMP” for appointing the smart lamp, “ON” to turn on the smart lamp, “OFF” to turn off the smart lamp. After the configuration, if the user wants to turn on the TV, the user may first sign “TV” to appoint the TV, and then signs “ON” to turn on the TV. In some embodiments, the remote devices to be appointed may depend on the device characteristics. If a particular characteristics is associated with only a single remote device, then the user may not need to appoint the device before giving the action command. For example, since the “U” signature is only associated with the TV, when the user wants to turn on the TV volume, the user only needs to sign “U” without the need to initially appoint the TV. In some embodiments, the remote devices to be appointed may depend on the device status, wherein the command will be appointed to the remote device that make the most logical sense for such appointment. For example, when the TV has already been turned off and the smart lamp is currently turned on, when a user signs “OFF” without first appointing which remote device to appoint the off command to, then only the smart lamp will be selected because it is the only device that can logically accept a turn-off command. In some embodiments, the remote devices to be appointed may depend on the device location relative to the mobile device, wherein the command will be appointed to the closest remote device that is capable of receiving such. For example, assume both the TV and the smart lamp are currently turned off. If a user now signs “ON” without appointing any remote device, then the command will be appointed to the TV if the mobile device is closer to the TV than the smart lamp.

Because each person's signature is unique, in some embodiments, once a user is authorized, the user can bring out his customized settings. The customized settings may include the user's account, favorite channels of a TV, preferred temperature of an air conditioner, preferred luminance and color of a smart lamp, preferred seat position of a vehicle, user's social media account (e.g. facebook) for sharing, etc.

In some embodiments, the authentication system may be duress-resistant by allowing a user to covertly send a silent alarm during the authentication process, indicating that the user is being forced to authenticate against his will. The user may send the silent alarm by specifying a signature to indicate the duress status. Once the silent alarm is received, the mobile device may display fake information adapted to deceive the adversary. In some embodiments, when an adversary is attempting to bypass the authentication system, the system may also display fake information adapted to deceive the adversary. For example, if a messaging application is protected by the authentication system, the fake information may be a messaging application displaying fake messages.

In some embodiments, the motion-based authentication system may accompany personal identity verification system, such as the automated self-service immigration checkpoints, electronic voting booth, or exam-taking station. One of the benefit for the motion-based authentication system is to replace the need for physical personal identification document (e.g. driver's license, passport, and student ID), thereby reducing the risk of personal data breaches.

As shown in FIG. 2, the invention provides a mechanism for motion-based authentication with a pre-training module 21 to familiarize the user with the authentication system 20. Once the user has been familiarized with the system, a training module 22 may be used to establish multiple sets of base signatures. Each set may be associated with a predefined user-specified function with a security level. For example, if a user wants to unlock a function of an application by signing “John” in the air, the system may first ask the user to establish a base signature of “John”. Once established, the system may validate all future target signatures against this base signature. Alternatively, to increase consistency, the system may ask the user to sign “John” three or more times to establish the “John” base signature set. The system may then validate all future target signatures against base signatures in the the base signature set.

As described below, the performance of the authentication system 20 depends on the quality of the base signatures. Hence, one goal of the pre-training module 21 and training module 22 is to assist the user in establishing a set of useful base signatures so that future validations of the target signatures will have a reliable authentication performance.

After the base signatures have been established, a verification module 23 may be used to verify whether a target signature can pass the authentication threshold associated with the base signatures. If it does pass, then the system may authorize the user to access the access-restricted resource.

In the pre-training module 21 of FIG. 2, a user of a mobile device can familiarize with the motion-based authentication system by completing the pre-training. Although it is expected that a user should be familiar with giving signatures on paper or on a touch-screen display of a mobile device, it may not be as familiar for the user to provide an air signature, in part due to the lack of visualization of the signature.

With a paper-based or screen-based signature authentication system, the user is asked to imprint the same mark as the one stored in the database, and the authentication is determined based on the similarity between these marks. On the contrary, with a motion-based authentication system, there is not an actual mark imprinted in air. Even if there were, the system does not actually compare the similarity between the target signature and base signature based on the actual marking. Instead, it is based on motion-related values associated with the user's action when signing in the air.

For example, a motion-based authentication system may record a user's signature based on the user's linear acceleration time series, and compute the similarity of the target signature with the base signature based on the time series. If so, then a user may leave the same mark in air but still fails the authentication if the acceleration time series of the two do not match. For example, if a user originally signs the base signature “John” in the air with a very slow and constant velocity, then the linear acceleration will be zero at most data points. Later on, if the user signs a target signature “John” with a very quick and non-constant velocity, then even if the two marks are substantially the same, their similarity score in a motion-based authentication system may be very different. This may result in the denied access to the restricted resource.

Due to the unintuitive nature of a motion-based authentication system, the motion-based authentication system 20 will provide a pre-training module 21, which is intended to familiarize the user with the essential skills necessary to use the system. According to some embodiments of the present invention, the pre-training module 21 may be a pre-recorded orientation or training programs. For example, the motion-based authentication system 20 may display a video on how to correctly interact with the system. In the video, the user may be reminded on his writing gesture and signature length to improve consistency in data capture.

Typically, when a user writes in a more comfortable gesture, the writing will have a higher consistency level, i.e., the user will have a higher chance of replicating his or her previous signatures. Thus, the pre-training module 21 may instruct the user to use more wrist movement instead of arm movement. This will typically allow the user to conserve energy and to have higher variety in terms of movement data. Therefore, the pre-training module 21 may optionally include a gesture recognition routine to determine whether the user is using too much arm movement instead of wrist movement.

In addition, the pre-training module 21 may also measure the complexity level associated with a signature. According to some embodiments of the present invention, the authentication system 20 may have a better performance when the complexity level of the signature is within a predefined range. In a real application, if the signature is too simple, e.g. a straight line or a circle, the authentication system 20 may reject the signature because it is too easy to replicate as a base signature. Once rejected, the system may provide feedbacks to the user and let the user understand the requirements of a good base signature, or the proper way of holding the device when signing in the air.

In the training module 22, the authentication system 20 allows a user to define the requirement for accessing the access-restricted resource. It also allows the user to establish base signatures. In some embodiments, the authentication system may first provide a user interface for the user to select the access-restricted resource.

As previously explained, the access-restricted resource may be a resource that can be accessed through the authentication system 20. For example, if the user would like to set access restriction to unlock a mobile device, or to make a purchase with an electronically stored payment information, then the user may set up such restriction through the authentication system 20.

The base signatures are used as the access credential in the authentication process. In some embodiments, the authentication system 20 may ask the user to provide an air signature only once and store the related time-series values associated with the signing motion. However, even if multiple signatures are provided by the same user, some varieties may still exist between each signature. Therefore, if the user provides only one signature for the base signature, it may not be enough representation of the user's habitual signing style. This may lead to the authentication system 20 being unable to capture the general signing pattern that is unique to the user. As a result, the system may be unable to verify the target signatures with high confidence.

In some embodiments, when the user is using a signature for resource with higher security concern, e.g. payment authorization, then the authentication system 20 may insist on a more complex signature pattern to reduce the risk of unauthorized access. With such application, the user may be asked to sign his entire name, e.g. “John Smith”, to offer enough complexity. On the other hand, if the user is using a signature to quickly launch a Facebook application, then the complexity demanded may be lower. With such application, a simple signing of “F” may suffice.

Due to the limitations of using only one signature as the base signature, in some embodiments of the present invention, the authentication system 20 may ask the user to provide multiple signatures to establish a more reliable access credential for the authentication.

In some embodiments, the authentication system 20 may ask the user to provide a fixed number of signatures. For example, the fixed number of signatures may be in the range of 2-7. In a preferred embodiment of the present invention, the fixed number may be 3. With such application, the authentication system 20 will request the user to provide multiple candidate signatures. All of the candidate signatures will then be stored as the base signatures.

In some embodiments, the authentication system 20 may ask the user to provide a fixed number of effective signatures. The fixed number of effective signatures may, for example, be in the range of 3-5. In a preferred embodiment of the present invention, the fixed number of effective signatures may be 3. Here, the authentication system 20 may disregard any candidate signature that is not qualified to be a base signature, and will ask the user to sign again and again until a predetermined number of effective signatures has been recorded. For example, if the authentication system 20 sets the number of effective signatures to be 3, then the user will be asked to sign at least three times. Among the three candidate signatures initially provided by the user, the authentication system 20 may disregard one of the candidate signatures that does not qualify as a good base signature.

Disqualification may be due to the signature motion being too short in time, too long in time, or too dissimilar from the other candidate signatures. If a candidate signature is disregarded, then the user may be asked to provide an additional candidate signature. This process may continue until enough effective signatures have been collected. Once collected, the effective signatures will then be used as the base signatures by the authentication system 20.

In some embodiments, the number of signatures that a user needs to provide depends on the consistency level of the set of signatures that the user has already provided. In some embodiments, the consistency level measures the variety among the signatures. If the signatures are very similar to the other, then the consistency level will be high. On way to measure the similarity between two signatures is to measure the distance among the motion time series after feature extraction, dynamic time warp, and dimensionality reduction. Therefore, if the distance between the two signatures is small, then the two signatures are very similar.

To illustrate, a user may at first be prompted to enter three candidate signatures. If the three candidate signatures provided are very consistent, e.g. the distances among the motion time series data are small enough, then the authentication system 20 may use the three candidate signatures as base signatures.

If the consistency level associated with the three candidate signatures are not satisfactory, e.g., the consistency level has not reached the consistency threshold, then the user may be prompt to enter an additional candidate signature. Each time when the user is asked to enter an additional candidate signature, the authentication system 20 may check the consistency level again for all candidate signatures that have been provided.

Alternatively, the consistency level may be computed only for a subset of the candidate signatures. In some embodiments, the consistency level is checked only for the set consisting the latest three submitted signatures. For instance, if the user has provided a total of four candidate signatures, only the consistency level for a set consisting of the second, third, and fourth signatures will be computed.

In other embodiments, the consistency level is computed only for a fixed number of candidate signatures that may offer the highest consistency level. Therefore, if the user has so far provided four candidate signatures, whereas the second attempt has a very bad consistency score compared to all the others, then the consistency level after the user has entered the fourth attempt may include only the first, third, and fourth attempts.

Once the consistency level is computed, the authentication system 20 may compare the new consistency level with the current consistency threshold. The current consistency threshold may be the original consistency level or may be a reduced threshold. If the current consistency level has reached the current consistency threshold, then the authentication system 20 may use those candidate signatures that were used for computing the current consistency level as the base signatures.

Otherwise, the authentication system 20 may continue prompting the user to provide an additional candidate signature and compare the new consistency level with the adjusted consistency threshold. In some embodiments, the consistency threshold used will be reduced by 20% each time the user is asked to input an additional candidate attempt. This will likely ensure that a terminal condition will be met. In addition, the authentication system 20 may also set the maximum number of attempts that it will prompt the user and reach the terminal conditions regardless of the consistency level at the final stage. Once the base signatures have been decided, the authentication system 20 will compute the consistency level associated with the base signatures if has not done so already.

In some embodiments, the initial consistency threshold may be set by the authentication system 20 to require a very high consistency. In other embodiments, the user may be prompted to provide the security level that the user would like to use for the authentication. If the user sets a high security level, e.g. for payment authorization purpose, then the consistency level associated with such application may initially be even higher.

In the verification module 23, the authentication system 20 verifies whether the target signature can pass the authentication condition associated with the base signature set. If it does, then the authentication system 20 may authorize the user to access the access-restricted resource.

When a user wants to access an access-restricted resource, the authentication system 20 may prompt the user to enter a signature in the air. In this regard, the system may initially provide a user interface to capture the target signature.

Once the data values associated with the target signature have been collected, these data values may go into the process substantially similar to the candidate signatures, e.g., feature extraction, dynamic time warp, and dimension reduction. Then, the similarity score of the target signature with each of the base signatures may be computed. Based on the similarity scores, the authentication system 20 may decide whether the user has the correct credential to access the access-restricted resource.

In some embodiments, the authentication system 20 will set a similarity threshold and grant access to a user only if the similarity scores between the target signature and each of the base signatures are higher than the similarity threshold. In other embodiments, the access will be granted if the percentage of the matched count is higher than the matching threshold. The percentage may be in the range of 40%-100%, and may preferably be 50%.

For example, if the base signature set has three base signatures, the authentication system 20 may grant access to a target signature only when the similarity scores between the target signature and each of the at least two base signatures are higher than the similarity threshold.

In some embodiments, the authentication system 20 may apply a weighting function for the similarity scores for each of the base signatures. Usually, the more recent base signature has more relevancy, and hence may be offered a higher weight. To illustrate, assume that there are three base signatures in the base signature set. In the verification module 23, the system may need to compute the similarity scores between the target signature with the first, second and third base signatures. Assume that the third base signature is the most recent one and the first base signature is the oldest one. As such, the authentication system 20 may apply a 20%, 30% and 50% weight to the similarity scores respectively toward the first, second and third similarity scores associated with the first, second and third base signatures. This will allow a more recent base signature to have a greater effect toward the authorization determination. In some embodiments, the authentication system 20 may provide a time threshold (e.g. 1 month) such that any base signature that was established prior to the time threshold will have a lower similarity threshold.

The similarity threshold may depend on the application security level so that a more secure application would demand a higher similarity threshold. It may also depend on a user's setting during the training module 22. In addition, when the consistency level of a base signature set is quite high, this means that the user has been very consistent in providing these signatures. In some embodiments, the authentication system 20 may demand a higher similarity threshold.

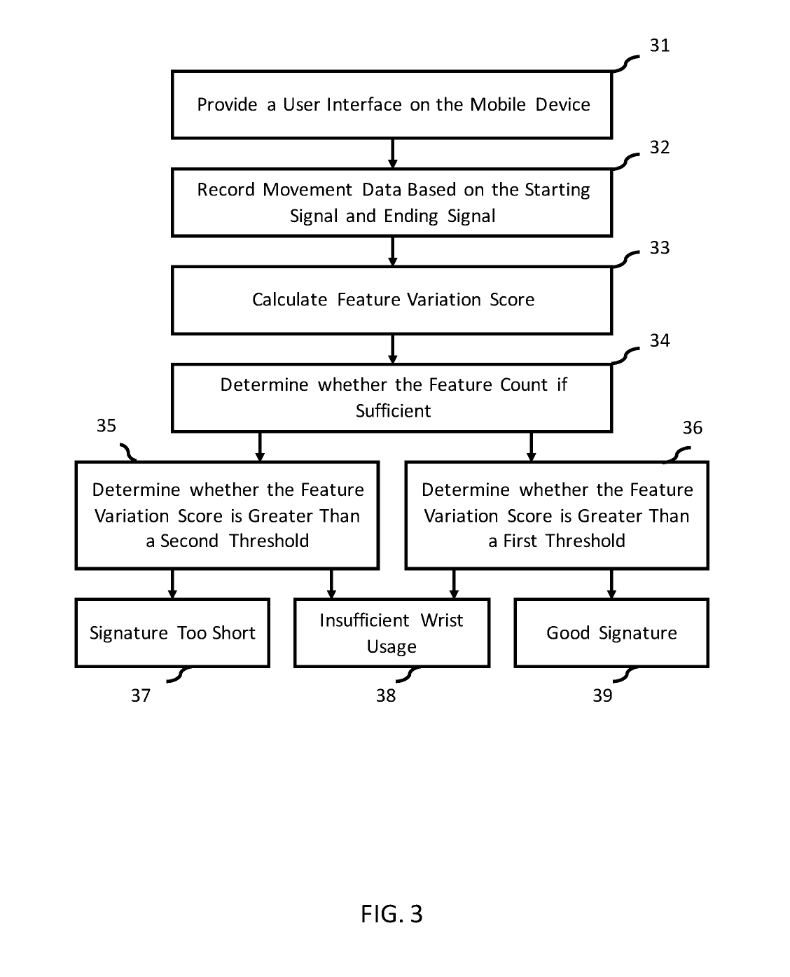

FIG. 3 illustrates a pre-training module of the motion-based authentication system in accordance with some embodiments of the present invention. As shown, at step 31, the system provides a user interface on the mobile device to the user. The user interface may include audio, visual, haptic or vibration feedback originated from the mobile device or a remote device.

At step 32, the system may record movement data based on the starting signal and ending signal. A starting signal may be generated by touching a predefined region or location, button click, above-threshold movement, or particular initiating movement (e.g. shaking, phone pick-up, circular motion, etc.). An ending signal may be triggered by an action that is contrary to the motion that triggers the starting signal. For example, the ending signal may be triggered by the stop of a movement, the un-touch of the screen or the un-click of a button.

The movement data may be obtained by initiating a sensor object, setting the appropriate sampling rate, selecting the desired sensor type, and then providing a call back function. In the preferred embodiment, the desired sensor type may be an accelerometer and a gyroscope. In addition, a person of ordinary skill in the art would recognize that the principle of the present invention is equally applicable for other kinds of movement sensors, such as a magnetic sensor or a video-graphic or photographic equipment, such as a camera.

Once the movement data has been collected, the system may compute the feature variation score at step 33. The feature variation score may be a score to measure the variation of the movement data. Usually, when the motion has more variation, it may be a better candidate for the base signature.

In some embodiments, the feature variation score may be associated with the absolute rotation value derived from the gyroscope readings. To illustrate, if the absolute rotation values from time 1 to time 10 are (89, 95, 100, 20, 13, 12, 20, 55, 78, 88), then the system may compute the feature variation score by setting a variation threshold of 30. After the variation threshold of 30 is set, the system may split the absolute rotation values into connected series. Each member of a connected series shall have a value that is all greater or all less than the threshold. In this example, the absolute rotation values may be split into a first group with higher values of (89, 95, 100) and (55, 78, 88), and a second group with lower values of (20, 13, 12, 20). Here, (89, 95, 100) is a connected series in the first group with higher values because they represent adjacent net rotation values, and each of them is higher than the threshold of 30.

Then, the system may compute the weight associated with each of the connected series by using W=N(N+1)/2, whereas N represents the number of elements in the connected series. For example, for the connected series (89, 95, 100), there are three elements so N=3, and the weight is W=3*(3+1)/2=6. Similarly, the connected series (55, 78, 88) has a weight of W=3*(3+1)/2=6. The connected series (20, 13, 12, 20) has a weight of W=4*(4+1)/2=10.

In some embodiments, the feature variation score is computed by the ratio of total weight in the first group with respect to the total weight in the first and second groups. In our example, the feature variation score may be (6+6)/(6+6+10)=0.545. A person of ordinary skill in the art will recognize that there can be any number of methods to compute the feature variation score.

Based on the feature variation score, at step 34, the system may compute whether there has been sufficient feature count in the signature. If there is, at step 36, the system may determine whether the feature variation score is greater than a first threshold. If so, then at step 39 the system will determine that the signature is a good signature. Otherwise, at step 38 the system may determine that there is insufficient wrist usage and then advise the user to use more wrist movement.

If the system decides that the feature count is not sufficient at step 34, then at step 35 the system may determine whether the feature variation score is greater than a second threshold. If it is, then at step 37 the system may determine that the signature is too short and prompt the user to provide a longer signature. Otherwise, at step 38 the system may determine that there is insufficient wrist usage and then advise the user to use more wrist movement.

In addition, the system may measure the angle of the mobile device with respect to Earth horizon during the signature movement. In some embodiments, we would prefer the user to sign with the screen facing downward or slightly upward. This will generally allow more consistency and comfort. Therefore, if the system detects that the user is writing with a screen facing upward, then it may prompt the user for the suggested writing gesture. As previously discussed, the mobile device 11 can calculate the tilt angle of the device relative to the direction of gravity through the accelerometer readings. As used herein, the “tilt angle” means the angle between (1) the outward-pointing normal vector direction for the touch screen surface and (2) the gravity direction pointing toward the center of the Earth. In some embodiments, we want the angle to be within a range of about 0 degree (when the screen is directly downward facing) to about 120 degrees (when the screen is slightly facing upward) during the user's signature process. It is preferable that most of the data points in this process have their tilt angles within the about 0-120 degrees range. In some embodiments, the user is considered to have passed the holding-position criteria if the percentage of the data points with the qualified tilt angel (e.g. within about 0-120 degrees) surpasses a predetermined threshold percentage (e.g. about 70%).

At steps 37 and 38 when the system decides that the signature is not a good signature, the system may play a movie to show the user of the correct signature gesture or may display text to show where the problem might be at. In addition, the system may ask the user to attempt one more time. At step 39 when the system decides that the signature is a good signature, the system may display a positive indication of such status.

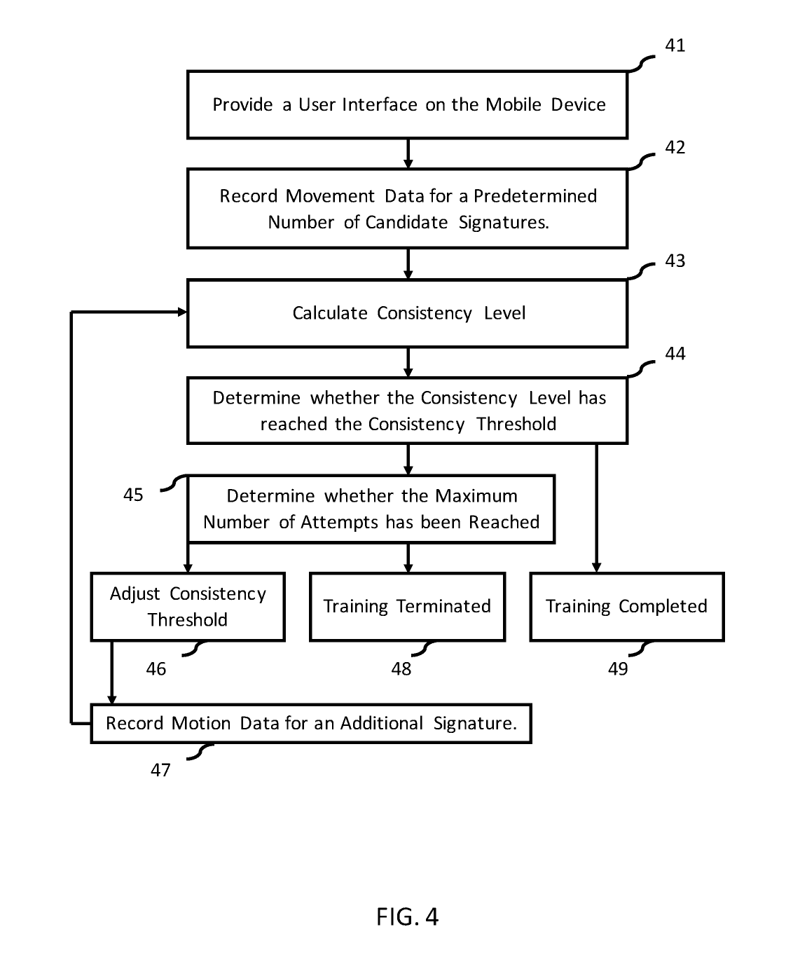

FIG. 4 illustrates a training module of the motion-based authentication system in accordance with some embodiments of the present invention. As shown, at step 41, the system provides a user interface on the mobile device to the user. At step 42, the system may record movement data based on the starting signal and ending signal associated for a predetermined number of candidate signatures. For example, the predetermined number of candidate signatures may be 3. This means that the user will be prompt to enter candidate signature at least three times.

At step 43, the consistency level of the candidate signatures is calculated based on the pair-wise feature distance between the candidate signatures. At step 44, the system determines whether the consistency level has reached the consistency threshold. In some embodiments of the present invention, the system will be initiated with a strong consistency threshold, and will gradually relax the threshold as the user enters more attempts.

Assume that the consistency level is discretized into the scale of 1 to 10 whereas the consistency level value of 1 indicates the strongest consistency and the consistency level value of 10 indicates the weakest consistency. If the consistency level calculated in step 43 has a value of 1 and the initial consistency threshold is also 1, then step 44 will determine that the consistency level has reached the consistency threshold, and at step 49 the training is completed.

If the consistency level computed in step 43 is 2, then at step 44, the system will determine that the consistency level has not reached the consistency threshold. Then, at step 45 the system will decide whether the maximum number of attempts has been reached. In some embodiments, the maximum number of attempts is set to be 7. This means that the training session will terminate at step 48 even if the consistency level still has not reached the consistency threshold. Once terminated, the system may ask the user to start again, or may use the last three candidate signatures as the base signatures with the weakest consistency.

If the maximum number of attempts has not been reached at step 45, then at step 46, the system may lower the consistency threshold. As previously described, the system may initially begin with a strong consistency threshold, and gradually relax the consistency threshold as the user enters more attempts. This will continue until the maximum number of attempts has been reached. For example, if the three candidate signatures fail the first consistency threshold test at step 44 with a consistency level of 1, the consistency threshold may then be changed from 1 to 2 at step 46. Then, at step 47, the user may be asked to provide an additional signature. Once provided, at step 43, the consistency level of the latest three candidate signatures will be computed. The newly computed consistency level will then be compared with the adjusted consistency threshold.

In our example, if the newly computed consistency level is 2, and the adjusted consistency threshold is also 2, then at step 49, the system will decide to use the latest three candidate signatures as the base signatures, and the training is completed. If the newly computed consistency level still has not reached the consistency threshold at step 44, then the consistency threshold may again be lowered at step 46 and an additional signature may be provided at step 47 until the maximum number of attempts has been reached in 305, or the training is completed in step 48.

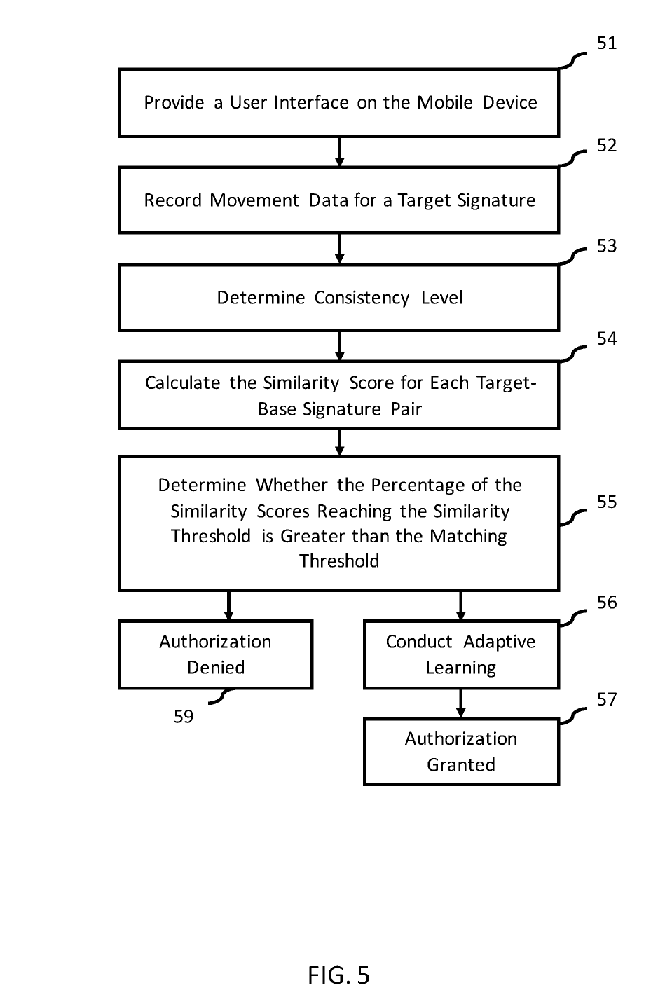

FIG. 5 illustrates a verification module of the motion-based authentication system in accordance with some embodiments of the present invention. As shown, at step 51, the system provides a user interface on the mobile device to the user. At step 52, the system may record movement data based on the starting signal and ending signal associated for a target signature.

At step 53, the consistency level of the verification signatures is calculated based on the time duration between the target signature and the latest base signature. If the time duration is longer than a threshold value, then the consistency level may be lowered. In addition, the system may adjust the consistency level based on the scenario of the application. For example, if the application is for payment authorization purpose, then the consistency level may be increased.

Based on the consistency level, at step 54, the system may calculate the similarity score for each of the target-base signature pairs. For example, when the system has three base signatures, this means that the system will compute three similarity scores between the target signature and the first, second, and third base signatures.

At step 55 the system will decide whether the percentage of the similarity scores reaching the similarity threshold is greater than matching threshold. For example, if more than half of the similarity scores are higher than the similarity threshold, then the system may decide that the matching threshold has been reached. The matching threshold may be in the range of 40%-100%, and may preferably be 50%.

Once the similarity threshold has been reached, at step 56, the system may optionally conduct an adaptive learning module to decide whether to use the target signature for adaptive learning. In such determination, the system may run the verification again. The verification may be conducted with or without the consistency level adjustment in step 53, or with a stronger consistency level. In a preferred embodiment, the target signature is used for learning only when the target signature is acceptable without the consistency level adjustment in step 53.

If a target signature has been decided to be used for the adaptive learning, then the target signature may be added to the base signature set to become the latest base signature. Alternatively, the target signature may be used to replace the oldest base signature, or to replace the base signature with the least similarity with respect to the others.

In some embodiments, the adaptive learning module in step 56 may include adjusting the consistency level associated with the base signatures. Such adjustment may be based on the number of most recent success attempts. For example, the consistency level may be increased by one unit if 9 out of the most recent 10 target signatures have been authorized.

After the optional adaptive learning at step 56, the authorization is granted at step 57. Otherwise, the authorization is denied at step 59.

In the related-art, when a user wants to start an online testing or a questionnaire, the user must input an identification information actively (such as an account and a password) to a system for authentication at first. After the system determines the identifying information is correct, the user is allowed to log into the system and answer the questions or the questionnaires with the identity of real user.

However, the scheme of the related-art encounters following problems:

(1) The other people can easily disguise as a real user. More specifically, people who know the identification information (referred to as fake user in following descriptions) can disguise as the real user. After logging into the system using the identification information, the fake user can answer the questions or the questionnaires with the identity of the real user. Or, the real user can pass the authentication and log in into the system at first, and the other people (such as an imposter) can then answer the questions or questionnaires for the real user. Thus, the scheme of the related-art fails to effectively detect the fake user.

(2) It is inconvenient for user. More specifically, before answering the questions or questionnaires, the user must consciously and additionally do an input operation of inputting the identification information (such as fingerprint or the above mentioned account and password). After the system determines the identification information is correct, the user is allowed to use the system for answering the questions or questionnaires. Thus, the system of the related-art cannot simultaneously execute the authentication and simplifying operations.

Therefore, there is a need to find out a better and more effective solution to handle such problems.

This present technical scheme is to use the air signature technology. This present technical scheme executes the authentication according to a behavior which would have been done by a user (an indispensable behavior). Before using the system (such as answering the online testing or questionnaire), the user does not need to consciously and additionally do the authentication, but the system automatically and simultaneously recognizes the identity of the user according to the indispensable behavior when the user directly does the indispensable behavior unconsciously (such as answering multiple choice questions, true-false questions, or short answer questions).

Preferably, in the air signature technology used in this present technical scheme, the user moves a handheld apparatus with a way of writing on a plane or in the air to do an air signature operation. Above way of writing on the plane or in the air is to imagine that the handheld apparatus is a pen. The user can hold the handheld apparatus to write on the plane or in the air to simulate an approximate scenario of using the pen to write. The handheld apparatus extracts the air signature of the user. Besides, the user can also do the air signature operation via directly moving the user's hand(s), and an additional camera is used to extract the motion of the user's hand(s).

Preferably, this present technical scheme regards the indispensable behavior such as the behavior of answering the questions for answering the questions or the questionnaire as an air signature operation, and transforms the air signature operation into an air signature information. Besides, this present technical scheme can further determine whether the air signature information is consistent with a registered signature information pre-registered by the user. If they are consistent, this present technical scheme completes this answering operation according to a command (such as a character command) corresponding to the registered signature information.

The efficacy of this present technical scheme is to effectively omit the additional identity information input operation. And this present technical scheme can simultaneously recognize the identity of the user and complete the answering operation when the user does the indispensable behavior. Because the way of writing and the habit of holding the handheld apparatus of everyone are different, the characteristics of the generated air signature information is unique, the others are difficult to disguise.

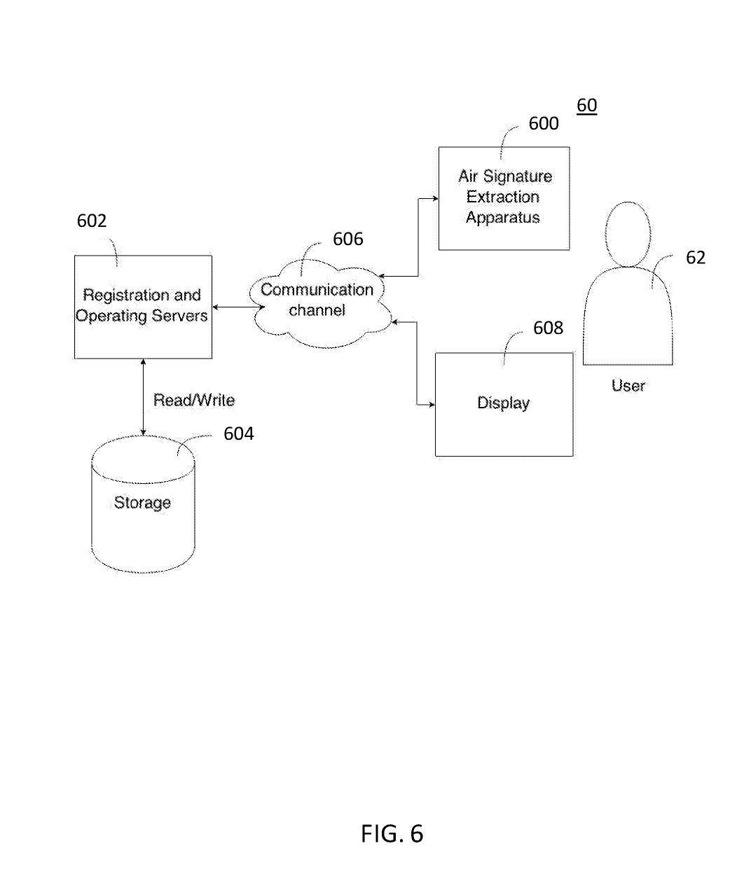

FIG. 6 is an architecture diagram of this present technical scheme. As shown in FIG. 6, an air signature operation system 60 of this present technical scheme comprises an air signature extraction apparatus 600, a registration and operating server 602, a storage 604 and a display 608.

The air signature extraction apparatus 600 can be a handheld apparatus preferably, and is used to extract or receive the air signature operation from a user 62. The air signature extraction apparatus 600 transforms the air signature operation into the air signature information, and transfer the transformed air signature information to the registration and operating server 602 via a communication channel 606.

Preferably, the air signature extraction apparatus 600 is used to extract the air signature of the user and store the air signature as the registered signature information in a registration phase before the answering operation, and extract the air signature and generate the air signature information in an operation phase.

Preferably, the air signature extraction apparatus 600 can also be an electronic apparatus (such as a smartphone, a smart ring, a smart wristband, etc.) installed with a motion sensor, an image capturing apparatus (such as a camera), or an electronic apparatus or electronic pen installed with a touchscreen, but this specific example is not intended to limit the scope of the disclosed example.

When the air signature extraction apparatus 600 is the electronic apparatus installed with the motion sensor, the air signature extraction apparatus 600 can transform the air signature operation into a plurality of motion-sensed values and regard as the air signature information.

When, the air signature extraction apparatus 600 is the image capturing apparatus, the air signature extraction apparatus 600 can extract a motion track of the air signature operation from captured images and regard as the air signature information.

When the air signature extraction apparatus 600 is the electronic apparatus or electronic pen installed with the touchscreen, the air signature extraction apparatus 600 extracts a motion track of the air signature operated upon the air signature extraction apparatus 600 and regard as the air signature information.

The registration and operating server 602 can receive the air signature information from the air signature extraction apparatus 600 via the communication channel 606. The registration and operating server 602 can execute a registration process or a recognition process to the received air signature information. Preferably, the registration and operating server 602 is a database or a web server with a web application program.

The registration and operating server 602 can comprise a registration module, an assertion module and an online testing/questionnaire module.

The registration module can regard the air signature information received in the register phase as the registered signature information of the user, and transfer the registered signature information to the storage 604 for storing. Preferably, the storage 604 is a database. Besides, the registration module can pair the registered signature information with a specific command (such as a character command or a text command) according to a setting of the user 62.

Taking a multiple choice questions operation for example, when the user 62 writes a character ‘a’ using the air signature extraction apparatus 600, the registration module writes the air signature information representing the character ‘a’ to the storage 604 as one of the plurality of registered signature information, and pair the registered signature information with a command “sending character ‘a’”.

When the user 62 writes a character ‘b’ using the air signature extraction apparatus 600, the registration module writes the air signature information representing the character ‘b’ to the storage 604 as one of the plurality of registered signature information, and pairs the registered signature information with a command “sending character ‘b’”.

When the user 62 writes a character ‘c’ using the air signature extraction apparatus 600, the registration module writes the air signature information representing the character ‘c’ to the storage 604 as one of the plurality of registered signature information, and pairs the registered signature information with a command “sending character ‘c’”.

When the user 62 writes a character ‘d’ using the air signature extraction apparatus 600, the registration module writes the air signature information representing the character ‘d’ to the storage 604 as one of the plurality of registered signature information, and pairs the registered signature information with a command: “sending character ‘d’”. The registration module keeps receiving and writing the registered signature information, until all choice options of the multiple choice questions operation have been registered and corresponded.

Taking a true-false questions operation for example, when the user 62 writes a character ‘O’ using the air signature extraction apparatus 600, the registration module writes the air signature information representing the character ‘O’ to the storage 604 as one of the plurality of registered signature information, and pairs the registered signature information with a command “sending character ‘O’”.

When the user 62 writes a character ‘X’ using the air signature extraction apparatus 600, the registration module writes the air signature information representing the character ‘X’ to the storage 604 as one of the plurality of registered signature information, and pairs the registered signature information with a command “sending character ‘X’”. The registration module keeps receiving and writing the registered signature information, until all choice options of the true-false questions operation have been registered and corresponded.

Taking a short answer questions operation for example, when the user 62 writes a character ‘a’ using the air signature extraction apparatus 600, the registration module writes the air signature information representing the character ‘A’ to the storage 604 as one of the plurality of registered signature information, and pairs the registered signature information with a command “sending character ‘A’”.

When the user 62 writes a character ‘b’ using the air signature extraction apparatus 600, the registration module writes the air signature information representing the character ‘B’ to the storage 604 as one of the plurality of registered signature information, and pairs the registered signature information with a command “sending character ‘B’”.

When the user 62 writes a character ‘c’ using the air signature extraction apparatus 600, the registration module writes the air signature information representing the character ‘C’ to the storage 604 as one of the plurality of registered signature information, and pairs the registered signature information with a command “sending character ‘C’”.

When the user 62 writes a character ‘d’ using the air signature extraction apparatus 600, the registration module writes the air signature information representing the character ‘D’ to the storage 604 as one of the plurality of registered signature information, and pairs the registered signature information with a command “sending character ‘D’”. The registration module keeps receiving and writing the registered signature information, until all letters, numbers and/or symbols of the short answer questions operation have been registered and corresponded.

The assertion module can compare the air signature information received by the air signature extraction apparatus 600 with any registered signature information stored in the storage 604 in the operation phase to determine whether the current user 62 is the registered user, and transfer the result to the display 608 for displaying.

The online testing/questionnaire module can retrieve and execute the command corresponding to the air signature information (in other words, the command corresponding to the registered signature information) when the assertion module determines that the current user is the real user (in other words, the air signature information is consistent with the registered signature information).

Taking the multiple choice questions operation for example, when the user 62 writes the character ‘a’ using the air signature extraction apparatus 600 and the assertion module determines the current user is the real user, the online testing/questionnaire module executes the paired command “sending character ‘A’”.

Taking the true-false questions operation for example, when the user 62 writes the character ‘O’ using the air signature extraction apparatus 600 and the assertion module determines the current user is the real user, the online testing/questionnaire module executes the paired command “sending character ‘O’”.

Take the short answer questions operation for example, when the user 62 writes the corresponding character(s) using the air signature extraction apparatus 600 and the assertion module determines the current user is the real user, the online testing/questionnaire module executes the paired command(s) for sending the corresponding character(s).

For example, when the user 62 sequentially writes the characters ‘n’, ‘a’, ‘m’ and ‘e’ using the air signature extraction apparatus 600 and the assertion module determines the current user is the real user, the online testing/questionnaire module sequentially executes the paired commands “sending character ‘N’”, “sending character ‘A’”, “sending character ‘M’” and “sending character ‘E’”.

The storage 604 is used to store the ID, the registered signature information and the command corresponding to the air signature information of the user 62.

The communication channel 606 is used to provide the transmission technology of exchanging data among the air signature extraction apparatus 600, the registration and operating server 602 and the display 608. The communication channel 606 can be implemented by the wired network, the wireless network, the internal bus of the system, etc. Preferably, the communication channel 606 is network protocol.

The display 608 is used to display information to be checked by the user 62.

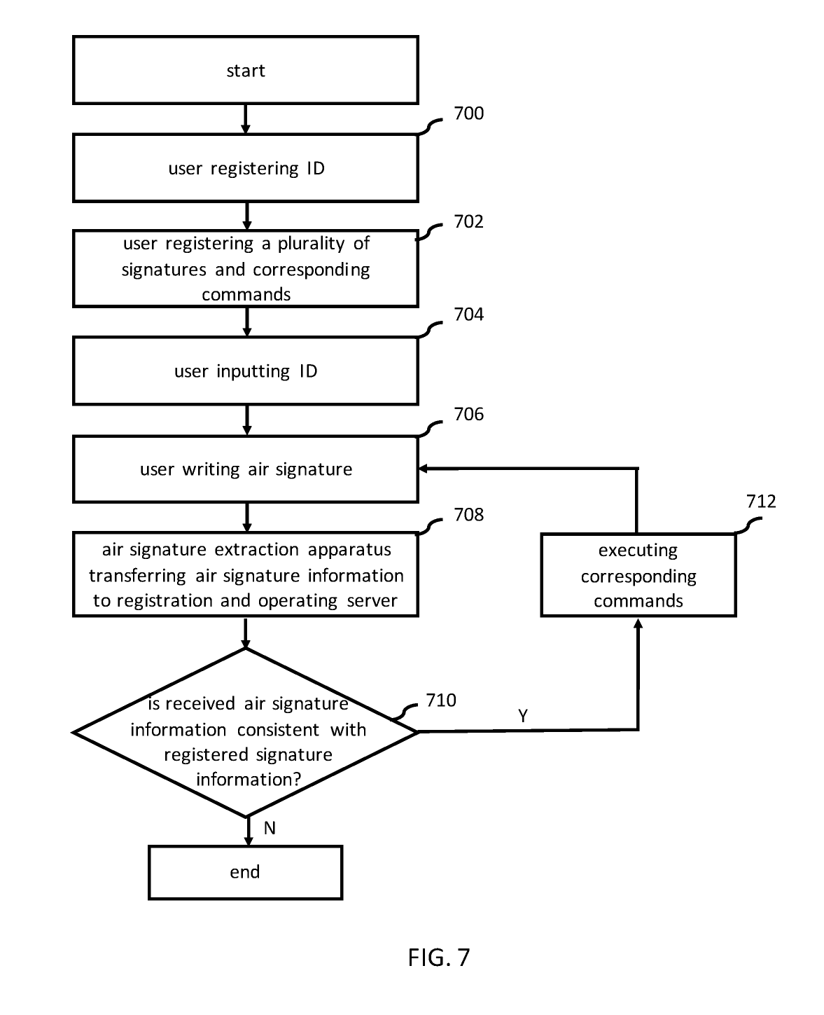

FIG. 7 is a flowchart of an air signature operation method of the present technical scheme. As shown in FIG. 7, the air signature operation method of the present technical scheme comprises following steps:

Step 700: the user 62 registers a unique ID to the registration and operating server 602.

Step 702: the user 62 respectively writes a plurality of air signatures stored as the registered signature information and configures the command(s) corresponding to each air signature using the air signature extraction apparatus 600.

Step 704: the user 62 inputs the ID to start using the system 60.

Step 706: the user 62 writes the air signature using the air signature extraction apparatus 600 (in other words, doing the air signature operation)

Step 708: the air signature extraction apparatus 600 extracts the air signature information from the air signature operation, and transfers the extracted air signature information to the registration and operating server 602.

Step 710: the registration and operating server 602 reads the registered signature information from storage 604, and compares the received air signature information with the read registered signature information to determine whether the current user 62 is the real user corresponding to the ID. If the received air signature information is not consistent with the read registered signature information, the registration and operating server 602 terminates the user operation. Otherwise, the registration and operating server 602 performs the following step 712.

Step 712: execute the command corresponding to the air signature information.

In the related art, an automatic call-answering function for cell phones had been disclosed. When the cell phone is under the standby status, the screen of the cell phone is configured to a locked status, and the cell phone is statically placed on the desktop by a user. When the cell phone receives a call request (such as Skype call request) and the user picks up the cell phone from the desktop, the cell phone can automatically switch to a talking status to enable the user to directly answer the call.

However, above automatic call-answering function of the related-art cannot recognize whether the user picking up the cell phone is the real user (the owner of the cell phone). In other words, when the cell phone receives the call request and the user picks up the cell phone, the cell phone will automatically switch to the talking status even the user is not the real user. Thus, the confidential and sensitive information of the real user may be leaked out by the current automatic call-answering function.

Therefore, there is a need to find out a better and more effective solution to handle such problems.

This present technical scheme is to use the air signature technology. This present technical scheme simultaneously executes the authentication according to a behavior which would have been done by a user (behavior of holding/picking-up handheld apparatus).

Preferably, the air signature technology used in this present technical scheme regards a behavior which the user moves a handheld apparatus with a specific way as an air signature operation, and transforms the air signature operation into an air signature information.

Above-mentioned moving with the specific way is that an indispensable behavior is done by the user for interacting with the handheld apparatus (such as picking up the handheld apparatus from the desktop or pocket). Because the behavior of holding/picking-up the handheld apparatus of everyone is different, the motion track of above indispensable behavior of each one is unique, the others are difficult to disguise.

Preferably, this present technical scheme is to transform the indispensable behavior done by the user for interacting with the handheld apparatus (behavior of holding/picking-up handheld apparatus) into an air signature information.

Besides, this present technical scheme can further compare the air signature information with a registered signature information pre-registered by the user for determining whether the user is the real user. If the user is the real user, this present technical scheme allows the handheld apparatus to interact with the user (such as automatically switching to the talking status or automatically displaying the content of SMS (Short Message Service)).

Under the standby status, the handheld apparatus is statically placed on the desktop, and its screen is configured to the locked status. When an interacting event is triggered (such as a Skype application program installed in the handheld apparatus receiving the call request), the user can pick up the handheld apparatus from the desktop, and place the handheld apparatus beside one of his/her ears.

Preferably, the interacting event is sent from the hardware or software of the handheld apparatus.

Then, the handheld apparatus can extract above holding/picking-up behavior of the user (the operation of picking up the handheld apparatus), and transform the behavior into the air signature information.

The handheld apparatus compares the transformed air signature information with the pre-stored registered signature information to determine whether the user is the real user (the owner of the handheld apparatus).

If the handheld apparatus determines that the user is the real user, the handheld apparatus can automatically change its screen to the unlock status, and interact with the user (such as automatically switching to the talking status to answer the call or automatically displaying the content of SMS).

If the handheld apparatus determines that the user is not the real user (in other words, the air signature information is not consistent with the registered signature information), the handheld apparatus does not interact with the user (in other words, the handheld apparatus does not change its screen to the unlock status, and does not switch to the talking status).

The efficacy of this present technical scheme is to recognize the user identity to determine whether the handheld apparatus is allowed automatically to interact with the user according to the indispensable behavior done by the user without any additional security information input operation (such as inputting an unlocking password or an unlocking pattern).

Besides, because the behavior of holding/picking-up the handheld apparatus of everyone is different, the characteristics of the generated air signature information of each one is unique, the others are difficult to disguise.

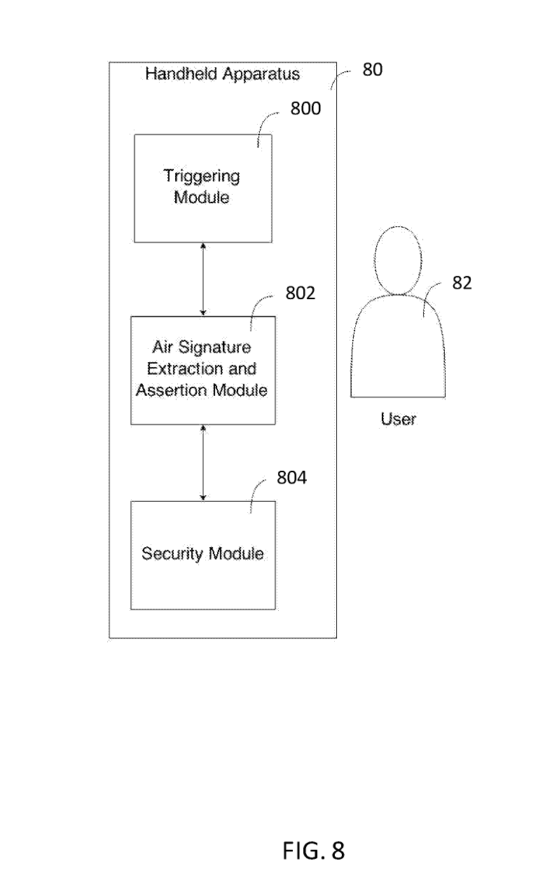

FIG. 8 is an architecture diagram of this present technical scheme. As shown in FIG. 8, the handheld apparatus 80 of this present technical scheme comprises a triggering module 800, an air signature extraction and assertion module 802 (referred to as the air signature module 802 hereinafter) and a security module 804. Above modules can be software modules, hardware modules or combination of software modules and hardware modules.

Preferably, the handheld apparatus 80 is a smartphone or a wearable apparatus (such as a smart ring or a smart wristband), but these specific examples are not intended to limit the scope of the disclosed examples.

The triggering module 800 generates an event needed to interact with a user 82, such as an external call event, an instant message displaying event, a calendar reminding event or a low battery warning event.

Preferably, the triggering module 800 can only interact with the user (such as answering the Skype call) after receiving a notification signal from the air signature module 802.

The air signature module 802 comprises an extraction module, a registration module, an assertion module, a storage module and a communication module.

The extraction module is used to extract the air signature operation of the user 82 (such as above-mentioned handheld apparatus holding behavior), and transform the air signature operation into the air signature information to execute a registration or a user authentication.

Preferably, the extraction module is used for the user 82 to register or to write the user's air signature.

The registration module is used to regard the air signature information as the registered signature information, pair the registered signature information with the user, and store the registered signature information in the storage module.

Preferably, the registration module can further provide a learning function. More specifically, when the user normally uses the handheld apparatus 80, the registration module can record the air signature information corresponding to the apparatus-holding behavior of the user 82, analyze the recorded air signature information (such as analyzing the motion characteristics), and automatically generate and record the registered signature information corresponding to the user 82 based on the analyzing result. Thus, this present technical scheme can enhance the accuracy of user authentication, and the user 82 can overcome the problem of registering the registered signature information consciously.

The assertion module is used to compare the received air signature information with the registered signature information. If the air signature information is consistent with the registered signature information, the assertion module determines that the user is the real user, and further sends the notification signal to the security module 804 and the triggering module 800.

Preferably, the assertion module automatically retrieves the air signature information, and execute above comparison when the triggering module generates the interacting event.

The storage module is used to store the registered signature information, which is to be compared with the air signature information.

The communication module is used to execute data transmission with the triggering module 800 and the security module 804.

The security module 804 is used for the security control of the handheld apparatus 80. The security module 804 can determine whether the user is a legitimate user (such as real user), and control the permissions of the handheld apparatus 80 using the authentication technology.

More specifically, after receiving the notification signal from the assertion module, the security module 804 can recognize that the current user is the legitimate user, and allow the handheld apparatus 80 to interact with the user 82 (such as unlocking the cell phone).

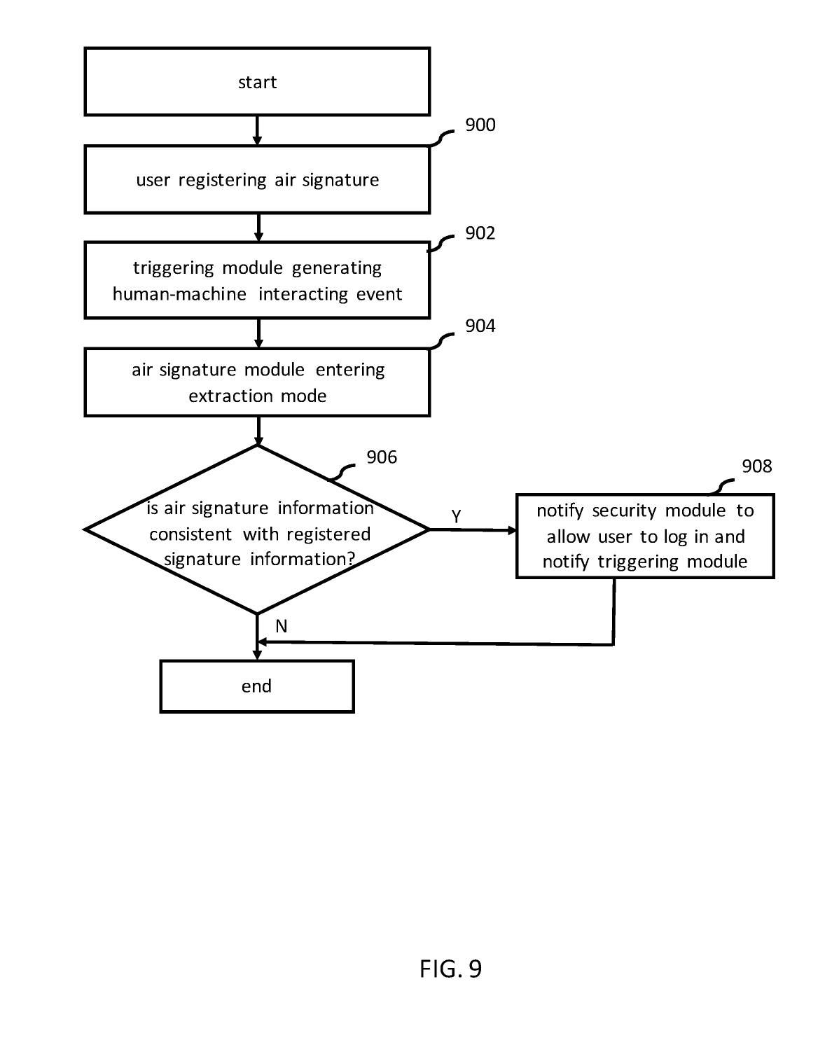

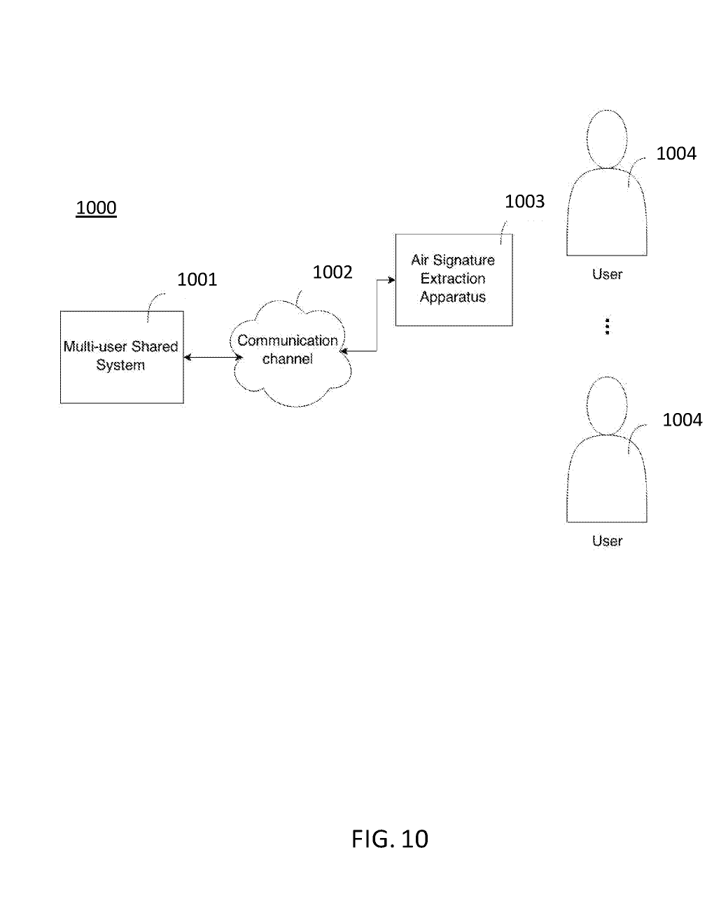

FIG. 9 is a flowchart of an air signature operation method of the present technical scheme. As shown in FIG. 9, the air signature operation method comprises following steps:

Step 900: the user registers the air signature.

Step 902: the triggering module 800 generates the event needed to interact with the user 82, such as external call, instant message displaying, calendar reminding or low battery warning.

Step 904: the air signature module 802 extracts the air signature (means the air signature operation) written by the user 82, and transforms the air signature operation into the air signature information.

Step 906: the air signature module 802 compares the transformed air signature information with the registered signature information, and determines whether the current user 82 is the real user by checking if the transformed air signature information is consistent with the registered signature information. If the transformed air signature information is not consistent with the registered signature information, the air signature module 802 terminates the user operation. If the transformed air signature information is consistent with the registered signature information, the air signature module 802 performs the following step 908.

Step 908: the air signature module 802 notifies the triggering module 800 and the security module 804 to allow the handheld apparatus 80 to interact with the user 82.

In the related-art, an authentication operation and a selection operation done by a user using an electronic device are independently executed. When the user wants to use the specific service (such as selecting confidential and sensitive data stored in the electronic apparatus), the user must do the authentication operation at first to pass an authentication procedure, and the user can then be allowed to execute the selection operation.

Taking the payment cards for example, before using a cell phone supporting the payment card transaction to pay, the user must pass the authentication procedure of the cell phone at first to confirm that the user is the real user (such as the owner of the cell phone or the payment card).

After the cell phone confirms that the user is the real user, the user can then select a payment information which the user wants to use from the cell phone, and uses the selected payment information to pay at a POS (Point Of Sales) system

Taking smart appliances (such as smart TV) for example, before selecting the specific information (such as selecting a premium channel), the user must pass an authentication procedure of the smart appliance at first to confirm that the current user is the real user.

After the smart appliance confirms that the current user is the real user, the user can then use a remote controller of the smart appliance to select the needed specific information (such as watching the premium channel).

Taking data access permissions for example, the permission of the user is usually fixed according to the ID of the user. The user cannot directly and dynamically change the permission when executing the authentication.

Thus, the scheme of the related-art is limited by the authentication technology, the user must independently and consciously do the authentication operation (such as inputting the password, inputting the fingerprint, etc.) at first to complete the authentication, and the user is allowed to execute the selection operation. The scheme of the related-art cannot simultaneously execute the authentication operation and the selection operation.

Therefore, there is a need to find out a better and more effective solution to handle such problems.

This present technical scheme is to use the air signature technology. Only need to do single behavior (the air signature operation), and the user can simultaneously complete both the authentication operation and the selection operation.

Preferably, the user can do a plurality of the air signature operations (for different selection operations) using the air signature extraction apparatus in advance, and the air signature extraction apparatus respectively transforms the plurality of air signature operations into a plurality of the air signature information.

Then, this present technical scheme respectively registers each air signature information as different registered signature information, and pairs each registered signature information with different command(s) (such as reading, sending, opening, closing, etc.) and parameter(s) (such as identity, permission, setting value, etc.). Among them, each registered signature information can be corresponded to one or more command(s) and one or more parameter(s), but these specific examples are not intended to limit the scope of the disclosed examples.

After the user executes one of the selection operations using the air signature apparatus, the air signature apparatus regards the selection operation as the air signature operation and transforms the air signature operation into the air signature information.

Then, the system can automatically and respectively compare the air signature information with the plurality of registered signature information to determine whether the user is the legitimate user (such as registered real user). If the user is the legitimate user (in other words, the registered signature information which is consistent with the air signature information corresponding to the air signature operation exists), the system further retrieves one or more of the command(s) and/or parameter(s) corresponding to the consistent registered signature information, executes one or more of the retrieved command(s) (such as executing “read” command (command 1) to retrieve “specific identity” parameter (parameter of the command 1), and executing “login” command (command 2) according to the retrieved parameter).

TABLE 1

| Registered | | First parameter of | Second parameter of |
|---|---|---|---|
| signature | | command 1(payment | command |
| information | Command 1 | card information) | 1(destination) |
| VISA | transferring | VISA-1234-xxxx | Induction module |
| MASTER | transferring | MASTER-7890-xxxx | Induction module |

Table 1 is a corresponding relationship table between the plurality of registered signature information, command and parameter. Table 1 is used to explain how to apply this present technical scheme to pay by the payment card.

Before paying by the payment card, the user can pre-register the plurality of registered signature information (such as “VISA” and “MASTER” shown in table 1) to an air signature extraction apparatus. The plurality of registered signature information is respectively corresponded to the different air signature operations, and is respectively corresponded to the different commands and parameters (in this example, the parameter is payment card information and transmission destination).

For example in Table 1, A first registered signature information “VISA” can be corresponded to a command 1 “transferring”, a first parameter of the command 1 (VISA-1234-xxxx) and a second parameter of the command 1 “Induction module”. A second registered signature information “MASTER” can be corresponded to a command 1 “transferring”, a first parameter of the command 1 (MASTER-7890-xxxx) and a second parameter of the command 1 “Induction module”

After the registration is completed, when the user wants to pay by the payment card, the user can use the air signature extraction apparatus to write the name of the payment card (such as “VISA” or “MASTER”) to complete the air signature operation.

Then, the air signature extraction apparatus transforms the air signature operation into the air signature information, and compares the air signature information with the plurality of registered signature information to authenticate whether the user is the real user. If the user is the real user (after passing the authentication), the air signature extraction apparatus further retrieves the parameter corresponding to the consistent registered signature information and executes the corresponding commands.

For example, the air signature extraction apparatus can comprise an induction module (such as Near Field Communication (NFC) module) used to wirelessly transfer data. If the user writes “VISA” and the comparing results is successful, the air signature extraction apparatus retrieves the first parameter of the command 1 “VISA-1234-xxxx” and the second parameter of the command 1 “Induction module” corresponding to the registered signature information “VISA”, and executes the corresponding command “transferring” to transfer the retrieved payment card information “VISA-1234-xxxx” to the induction module.

If the user writes “MASTER” and the comparing results is successful, the air signature extraction apparatus retrieves the first parameter of the command 1 “MASTER-7890-xxxx” and the second parameter of the command 1 “Induction module” corresponding to the registered signature information “MASTER”, and executes the corresponding command “transferring” to transfer the retrieved payment card information “MASTER-7890-xxxx” to the induction module.

Finally, the air signature extraction apparatus can transfer the retrieved payment card information to the POS system to pay with a wireless way via the induction module.

When this present technical scheme is applied to a smart appliance, user can pre-register a plurality of air signatures to the smart appliance, and respectively pair the plurality of air signatures with different information of the smart appliance.

When the user wants to select a specific information, the user can directly write the information name according to the specific information of the smart appliance using an air signature extraction apparatus (such as a remote controller of the smart appliance, a smartphone or a tablet PC connected to the smart appliance).

Then, the smart appliance or the air signature extraction apparatus recognizes whether the current user is the real user according to the air signature operation. If the current user is the real user, the smart appliance or the air signature can directly selects the information corresponding to the air signature operation.

Taking shopping on a shopping platform connected via smart TV for example, users can respectively register their air signature and configure their payment card information.

When a first user writes “BUY” using the air signature apparatus, the smart TV or the air signature extraction apparatus can recognize that the current user is the first user according to the air signature, and select the payment card information corresponded to the first user to pay.

When a second user writes “BUY” using the air signature apparatus, the TV system can recognize that the current user is the second user, and select the payment card information corresponded to the second user to pay, and so on.

TABLE 2

| | | First | Second | |
|---|---|---|---|---|
| Registered | | parameter of | parameter of | |
| signature | | command 1 | command 1 | |
| information | Command 1 | (ID) | (Password) | Command 2 |
| FB | Login | MATT | MattPass | Post photo |
| | Facebook | | | |
| FB | Login | ROSA | RosaPass | Post photo |
| | Facebook | | | |

Table 2 is a corresponding relationship table between a plurality of registered signatures, commands and parameters. The corresponding relationship table is used to explain how to apply this present technical scheme for automatic connection to a social networking site (such as Facebook) via the smart TV.

Before connecting to the social networking site, users can respectively register their registered signature information using their air signature, and pair their registered signature information with their social networking site account and content of an automatic executing command.

For example in Table 2, a first user can register the registered signature information “FB” using the first user's air signature, and pair the registered signature information with a command 1 “Login Facebook”, a first parameter of the command 1 “MATT” (the social networking site account of the first user), a second parameter of the command 1 “MattPass” (the social networking site password of the first user) and a command 2 “Post photo”.

For other example in Table 2, a second user can register the registered signature information “FB” using the second user's air signature, and pair the registered signature information with a command 1 “Login Facebook”, a first parameter of the command 1 “ROSA” (the social networking site account of the second user), a second parameter of the command 1 “RosaPass” (the social networking site password of the second user) and a command 2 “Post photo”.

After the registration is completed, when the first user wants to post a picture on the social networking site, the first user can write the name of the social networking site (such as “FB”) using the air signature extraction apparatus.

Then, the smart TV or the air signature extraction apparatus can recognize that the current user is the first user according to above air signature, select the identity and password of the first user, log in the social networking site using the social networking site account of the first user, and post the picture according to the social networking site account.

In other words, after the first user writes “FB” using the air signature extraction apparatus, the smart TV or the air signature extraction apparatus can retrieve the first parameter of the command 1 “MATT” and the second parameter of the command 1 “MattPass” corresponding to the first user, and execute the command 1 “Login Facebook” to log in into Facebook using the retrieved account and password of the first user. Then, the smart TV or the air signature extraction apparatus executes the command 2 “Post photo” to post the picture on Facebook by using the identity of the first user.

When the second user wants to post the picture on the social networking site, the second user can write the name of the social networking site by using the air signature extraction apparatus.

Then, the smart TV or the air signature extraction apparatus can recognize that the current user is the second user according to above air signature, select the identity of the second user, log in into the social networking site by using the social networking site account of the second user, and post the picture according to the social networking site account, and so on.

In other words, after the second user writes “FB”, the smart TV or the air signature extraction apparatus can retrieve the first parameter of the command 1 “ROSA” and the second parameter of the command 1 “RosaPass” corresponding to the second user, and execute the command 1 “Login Facebook” to log in into Facebook using the account and password of the second user. Then, the smart TV or the air signature extraction apparatus executes the command 2 “Post photo” to post the picture on Facebook by using the identity of the second user.

Taking watching the news channel via the smart TV for example, users can respectively register their air signature and configure a news channel they like.

When a first user writes “NEWS” by using the air signature extraction apparatus, the smart TV or the air signature extraction apparatus can recognize the current user is the first user according to the air signature, and automatically select the news channel which the first user likes.

When a second user writes “NEWS” using the air signature extraction apparatus, the smart TV or the air signature extraction apparatus can recognize the current user is the second user according to the air signature, and automatically select the news channel which the second user likes, and so on.

Taking smart lighting for example, users can respectively register their air signature and configure a corresponding personalized information and a corresponding control operation.

When a first user writes “ON” using the air signature extraction apparatus (such as a controller of the lighting system, a smartphone or tablet PC connected to the lighting system), the lighting system can recognize that the current user is the first user according to the air signature, select the corresponding personalized information (such as selecting the lighting device arranged in a room of the first user), and execute the corresponding control operation (such as turning on the above lighting device).

When a second user writes “ON” using the air signature extraction apparatus, the lighting system can recognize that the current user is the second user according to the air signature, select the corresponding personalized information (such as selecting the lighting device arranged in a room of the second user), and execute the corresponding control operation (such as turning on the above lighting device).

Taking smart entrance guarding system for example, users can respectively register their air signature and configure a corresponding authentication and a corresponding control operation.

When a first user writes “OPEN” using the air signature extraction apparatus (such as a controller of the smart entrance guarding system, a smartphone or tablet PC connected to the smart entrance guarding system), the smart entrance guarding system can recognize that the current user is the first user according to the air signature, execute the corresponding control operation (such as opening the door), and select and transfer the corresponding identification information of the first user to the smart entrance guarding system for recording.

TABLE 3

| Registered | | Parameter | | Parameter of | | Parameter of |
|---|---|---|---|---|---|---|
| signature | | of | | command | | command |
| information | Command 1 | command 1 | Command 2 | 2 (music) | Command 3 | 3 (volume) |
| PLAY | Displaying | First | Play | Song A | Setting | 9 |
| | | user | | | volume | |
| PLAY | Displaying | Second | Play | Song B | Setting | 3 |
| | | user | | | volume | |

Table 3 is a corresponding relationship table between a plurality of registered signatures, commands and parameters. The corresponding relationship table is used to explain how to apply this present technical scheme to a smart stereo set system to execute automatic playback.

Before executing automatic playback, users can respectively register the registered signature information by using their air signature, and configure a corresponding identification information, a corresponding personalized information and a corresponding control command.

For example in Table 3, a first user can firstly register the registered signature information “PLAY” by using the first user's air signature, and pair the registered signature information with a command 1 “display”, a parameter of the command 1 “first user” (the identity information of the first user), a command 2 “play”, a parameter of the command 2 “Song A”, a command 3 “setting volume” (the personalized control command of the first user) and a parameter of the command 3 “9” (the personalized information of the first user).

For other example in Table 3, a second user can firstly register the registered signature information “PLAY” by using the user's air signature, and pair the registered signature information with a command 1 “display”, a parameter of the command 1 “second user”(the identity information of the second user), a command 2 “play”, a parameter of the command 2 “Song B”, a command 3 “setting volume”(the personalized control command of the second user) and a parameter of the command 3 “3” (the personalized information of the second user).

After the registration is completed, when the first user writes “PLAY” using an air signature extraction apparatus (such as a controller of the smart stereo set system, a smartphone or a tablet PC connected to the smart stereo set system), the smart stereo set system can recognize that the current user is the first user according to the air signature, execute the corresponding control command (such as turning on the smart stereo set device), and display as well as transfer the identity information and the personalized information (such as default music and default volume level) of the first user to a stereo set device of the smart stereo system.

For example, after the first user writes “PLAY”, the smart stereo set system can execute the command 1 “display” to retrieve and display the pre-configured parameter “first user” of the command 1 corresponding to the first user.

Then, the smart stereo set system retrieves the parameter of the command 2 “Song A”, and executes the command 2 “play” to play the Song A according to the retrieved parameter of the command 2.

Then, the smart stereo set system retrieves the parameter “9” of the command 3, and executes the command 3 “setting volume” to configure the playback volume level of the smart stereo set system to 9 according to the retrieved parameter of the command 3.

When the second user writes “PLAY” using an air signature extraction apparatus, the smart stereo set system can recognize that the current user is the second user according to the air signature, execute the corresponding control command, and display as well as transfer the identity information and the personalized information of the second user to the stereo set device.

For example, after the second user writes “PLAY”, the smart stereo set system can execute the command 1 “display” to retrieve and display the pre-configured parameter of the command 1 “second user” corresponding to the second user.

Then, the stereo set system retrieves the parameter of the command 2 “Song B”, and executes the command 2 “play” to play the Song A according to the retrieved parameter of the command 2.

Then, the stereo set system retrieves the parameter “3” of the command 3, and executes the command 3 “setting volume” to configure the playback volume level of the smart stereo set system to 3 according to the retrieved parameter of the command 2.

Taking smart air condition system for example, users can respectively register their air signature and configure a corresponding identity information, a corresponding and personalized information and a corresponding control operation.

When a first user writes “ACON” using the air signature extraction apparatus (such as a controller of the smart air condition system, a smartphone or a tablet PC connected to the smart air condition system), the smart air condition system can recognize that the current user is the first user according to the air signature, execute the corresponding control operation (such as turning on an air condition device of the smart air condition system), select the identity information of the first user, transfer the selected identity information to an air condition device to display, and configure the air condition device according to the personalized information (such as default temperature and default fan speed level).

This present technical scheme can also be applied to data access permission configuration. More specifically, a user can pre-registers a plurality of air signatures, and respectively pair the plurality of air signatures with different data access permissions.

When the user wants to select a specific data access permission, the user can directly execute the air signature operation (such as writing the name of the specific data access permission) using an air signature extraction apparatus.

Then, the system recognizes whether the current user is the real user according to the air signature operation. If the current user is the real user (in other words, after passing the authentication of the system), the system can directly configure the permission of the user to the data access permission corresponded to the air signature.

Taking data access operation for example, the user can register a plurality of air signatures and respectively pair the plurality of air signature with different data access permissions.

For example, when the user writes “READ” by using the air signature extraction apparatus, a data access system (such as a file server or a database system) can recognize that the current user is the real user according to the air signature, and simultaneously configure the permission of the user to the permission “Readable” corresponded to the air signature.

In another example, when the user writes “WRITE” using the air signature extraction apparatus, the data access system can recognize that the current user is the real user according to the air signature, and simultaneously configure the permission of the user to the permission “Writable” corresponded to the air signature.

Taking data security operation for example, the user can register a plurality of air signatures and respectively pair the plurality of air signature with different data.

For example, when the user writes “TRUE” by using the air signature extraction apparatus, the data access system can recognize that the current user is the real user according to the air signature, and simultaneously select and read true data of the data access system according to the air signature.

When the user is threatened, the user can write “FAKE” using the air signature extraction apparatus, the data access system can recognize that the current user is the real user according to the air signature, and simultaneously select and read fake data of the data access system according to the air signature.

Thus, this present technical scheme can prevent the true data from leaking out under the condition that the user is threatened.

The efficacy of this present technical scheme is to effectively overcome the problem resulted from executing the additional authentication operation. Also, this present technical scheme can simultaneously recognize the identity of the user when the user executes the selection operation.

FIG. 10 is an architecture diagram of this present technical scheme. As shown in FIG. 10, an air signature operation system 1000 (referred to as the system 1000 hereinafter) of this present technical scheme comprises an air signature extraction apparatus 1003 and a multi-user shared system 1001.

The air signature extraction apparatus 1003 can extract the air signature operation of the users 1004 and generate the air signature information corresponding to the air signature operation. Preferably, the air signature extraction apparatus 1003 is used when the users 1004 register or write their air signature. Preferably, the air signature extraction apparatus 1003 can be an electronic apparatus (such as a smartphone, a smart ring, a smart wristband, etc.) installed with a motion sensor, image capturing apparatus (such as a camera), or an electronic apparatus or electronic pen installed with a touchscreen, but this specific example is not intended to limit the scope of the disclosed example.

When the air signature extraction apparatus 1003 is the electronic apparatus installed with the motion sensor, it can transform the air signature operation into a plurality of motion sense values and regard them as the air signature information.

When the air signature extraction apparatus 1003 is the image capturing apparatus, it can extract a motion track of the air signature operation from captured images and regard the motion track as the air signature information.

When the air signature extraction apparatus 1003 is the electronic apparatus or electronic pen installed with the touchscreen, it can extract a motion track of the air signature which is operated thereon and regard the motion track as the air signature information.

Preferably, the air signature extraction apparatus 1003 can comprise a registration module, an assertion and selection module and a storage module.

The registration module can be used to receive the plurality of air signatures of the users 1004 and respectively register the plurality of register air signature information according to the plurality of air signatures, and configure the plurality of register air signature information to respectively correspond to different commands and parameters (such as identify or permission). Among them, each registered signature information can be corresponded to one or more of command(s) and one or more of parameter(s).

Taking payment cards for example, the user 1004 can complete the air signature operation via writing the name of the payment card (such as “VISA” or “MASTER”). The registration module can extract the air signature information corresponding to the air signature operation, store the air signature information as the registered signature information, and pair the registered signature information with a payment card information (such as VISA credit card information or MASTER credit card information).

Taking smart appliances for example, the user can complete the air signature operation via writing an information name. The registration module can extract the air signature information corresponding to the air signature operation, store the air signature information as the registered signature information, and pair the registered signature information with one or more of information.

For example, when the user 1004 writes the name of the user 1004, the information can be the account and the password of the user 1004. When the user 1004 writes “NEWS”, the information can be the favorite news channel of the user 1004.

Taking data access permissions for example, the user 1004 can complete the air signature operation via writing an permission name. The registration module can extract the air signature information corresponding to the air signature operation, store the air signature information as the registered signature information, and pair the registered signature information with a permission.

For example, when the user 1004 writes “READ”, the command is to configure the permission of the user 1004 to “readable”. When the user 1004 writes “WRITE”, the command is to configure the permission of the user 1004 to “writable”.

In another example, when the user 1004 writes “TRUE”, the command is to read true data. When the user writes “FAKE”, the command is to read fake data.

The assertion and selection module determines whether the current user 1004 is the real user by determining whether the received air signature information is consistent with the stored registered signature information. If the current user 1004 is the real user, the assertion and selection module selects one or more command(s) and one or more parameters corresponding to the consistent registered signature information.

The storage module is used to store the registered signature information, the corresponding one or more command(s) and the corresponding one or more parameters.

Please be noted that the assertion and selection module and/or the storage module can be implemented in the air signature extraction apparatus 1003 or the multi-user shared system 1001, but this specific example is not intended to limit the scope of the disclosed example.

The multi-user shared system 1001 is connected to the air signature extraction apparatus 1003 to receive and process the information transferred from the air signature extraction apparatus 1003 via a communication channel 1002.

Taking payment card application for example, the multi-user shared system 1001 can be the POS (Point of Sales) system. The multi-user shared system 1001 can receive the payment card information from the air signature extraction apparatus 1003, and execute the payment operation.

Taking smart appliance application for example, the multi-user shared system 1001 can be the smart appliance (such as smart TV). The multi-user shared system 1001 can receive the information from the air signature extraction apparatus 1003, and execute operations (such as logging by using the account and password of the user, and switching to the corresponding channel).

Taking data access permissions application for example, the multi-user shared system 1001 can receive the permission information of the user 1004 from the air signature extraction apparatus 1003, and configure the permission of the user 1004.

The communication channel 1002 is used to provide the transmission technology of exchanging data between the air signature extraction apparatus 1003 and multi-user shared system 1001. Preferably, the communication channel 1002 can be implemented by the wired network, the wireless network, the internal bus of the system, etc.

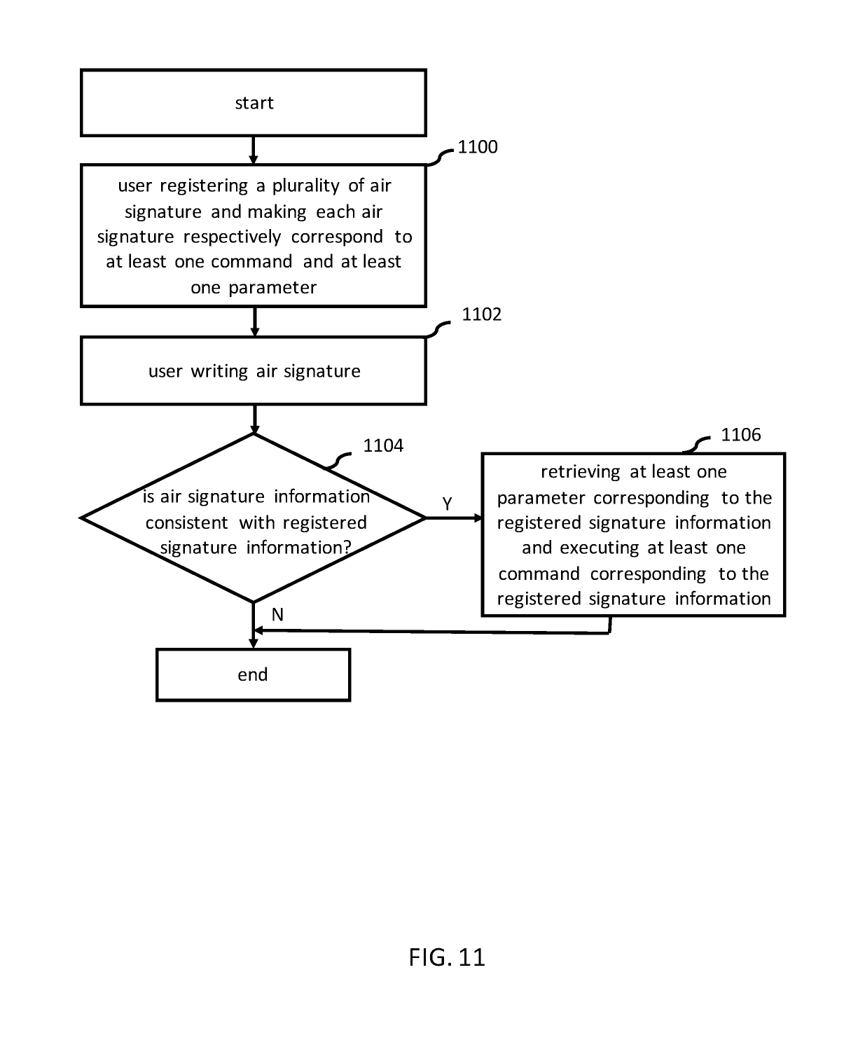

FIG. 11 is a flowchart of an air signature operation method of the present technical scheme. As shown in FIG. 11, the air signature operation method of the present technical scheme comprises following steps:

Step 1100: the user 1004 writes the plurality of air signatures using the air signature extraction apparatus 1003, stores the plurality of air signatures as the plurality of registered signature information, and respectively configures one or more of command(s) and one or more of parameter(s) corresponding to each registered signature information.

Step 1102: the user 1004 writes the air signature by using the air signature extraction apparatus 1003.

Step 1104: determining if the current user 1004 is the real user by checking whether the air signature information is consistent with the registered signature information. If the current user 1004 is the real user, the system executes step 1106. If the current user 1004 is not the real user, the system terminates the operation of the user 1004.

Step 1106: retrieving the parameter corresponding to the consistent registered signature information and execute the command corresponding to the consistent registered signature information.

Although the invention has been described with reference to specific embodiments regarding the mobile device, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method of authenticating a user with a mobile device, the mobile device including a touch-sensitive display and a motion detector, the method comprising:
conducting a pre-training routine to evaluate an overall orientation characteristic associated with at least one pre-training signature of the user, and providing an overall orientation feedback if the overall orientation characteristic is below an orientation threshold;
conducting a training routine to capture a plurality of base signatures;
conducting a verification routine to record a target signature, and to authorize access to an access-restricted resource if the target signature has reached a similarity threshold.

2. The method of claim 1, wherein said overall orientation characteristic comprises a tilt angle evaluation for a plurality of tilt angles of the at least one pre-training signature.

3. The method of claim 2, wherein said overall orientation feedback is below the orientation threshold if a percentage of the plurality of tilt angles within a predetermined tilt angle range is below a predetermined tilt angle percentage threshold.

4. The method of claim 3, wherein said overall orientation feedback comprises a first message to the user that suggests more wrist movement.

5. The method of claim 4, wherein said pre-training routine further comprises:
evaluating a duration characteristic and providing a duration feedback if the duration characteristic is below a duration threshold.

6. The method of claim 5, wherein said duration feedback comprises a second message to the user that suggests a longer pre-training signature.

7. The method of claim 6, wherein said pre-training routine further comprises:
calculating a feature variation score;
determining whether a feature count is sufficient; and
providing a third message to the user that suggests a more complex pre-training signature.

8. The method of claim 7, wherein said training routine further comprises:
calculating a training consistency level of a plurality of candidate signatures;
determining whether the training consistency level has reached a training consistency threshold; and
determining that a training is completed if the training consistency level has reached a training consistency threshold.

9. The method of claim 8, wherein said training routine further comprises:
adjusting the training consistency threshold and prompting the user for an additional attempt if the training consistency level has not reached a training consistency threshold and a maximum number of attempts has not been reached.

10. The method of claim 9, wherein said verification routine further comprises:
determining a verification consistency level;
calculating a similarity score for each target-base signature pair; and
determining whether a verification similarity threshold has been reached.

11. The method of claim 10, wherein said verification consistency level is relaxed in accordance with a time difference between the target signature and a most recent base signature in the plurality of base signatures.

12. The method of claim 11, wherein the access-restricted resource comprises a native application installed and executed on the mobile device.

13. The method of claim 12, wherein the access-restricted resource comprises a native application installed and executed on a remote device.

14. The method of claim 13, wherein the access-restricted resource comprises a web application running on a web server.

15. The method of claim 14, wherein the access-restricted resource comprises the user's customized settings.

16. The method of claim 15, wherein the access-restricted resource comprises unlocking the mobile device and activating an application that is uniquely associated with the target signature.

17. The method of claim 16, wherein the access-restricted resource comprises activating an application in the mobile device associated with an icon displayed by the mobile device and touched by the user while providing the target signature.

18. The method of claim 17, wherein the access-restricted resource comprises granting access for a remote device to access-restricted information stored in a server device.

19. The method of claim 18, wherein the access-restricted resource comprises payment authorization.

20. The method of claim 19, wherein the access-restricted resource comprises login authentication.
